(19) United States
(12) Patent Application Publication
(10) Pub. No.: US 2026/0264858 A1
(43) Pub. Date: Sep. 10, 2026

(54) BRACKET KITS, BRACKETS, ASSEMBLIES, AND METHODS FOR AIRCRAFT INTERIOR STRUCTURES

(71) Applicant: The Boeing Company, Arlington, VA (US)

(72) Inventors: Edward H. CHUE, Bellevue, WA (US); Andrew A. BOYLES, Corvallis, OR (US)

(21) Appl. No.: 19/322,223

(22) Filed: Sep. 8, 2025

Related U.S. Application Data
(63) Continuation-in-part of application No. 19/073,569, filed on Mar. 7, 2025.

(51) Int. Cl. B64D 11/00; B64F 5/10

(52) U.S. Cl. CPC B64D 11/00; B64F 5/10

(57) ABSTRACT

Bracket kits for coupling panels together at an angle comprise an exterior bracket and an interior bracket. The exterior bracket has an exterior-bracket first wall having an exterior-bracket first-wall inner face and an exterior-bracket first-wall outer face opposite the exterior-bracket first-wall inner face, an exterior bracket second wall, and a first projection extending from the exterior-bracket first-wall inner face. The interior bracket has an interior-bracket first wall, an interior-bracket second wall having an interior-bracket second-wall inner face and an interior-bracket second-wall outer face opposite the interior-bracket second-wall inner face, and a second projection extending from the interior-bracket second-wall outer face The exterior-bracket second wall defines an exterior-bracket second-wall fastener hole extending through the exterior-bracket second wall. The interior-bracket first wall defines an interior-bracket first-wall fastener hole extending through the interior-bracket first wall. The first projection defines a first-projection fastener hole. The second projection defines a second-projection fastener hole.

### RELATED APPLICATION

This application is a continuation-in-part of and claims priority to U.S. Patent Application No. 19/073,569, filed on Mar. 7, 2025, the complete disclosure of which is incorporated herein by reference.

### FIELD

The present disclosure relates to the assembly of aircraft interiors.

### BACKGROUND

Aircraft interiors are often constructed using sandwich panels due to their high strength-to-mass ratio. However, aircraft interior structures constructed of sandwich panels, such as stowage bins, closets, lavatories, shelving units, interior bulkheads, crew rest compartments, and the like typically require significant assembly time that utilizes liquid adhesives that require clean-up. Such aircraft interior structures are often constructed utilizing mortise-and-tenon joints, ‘cut-and-fold’ joints, or potted inserts, whose quality and structural integrity largely depend on operator skill and diligence. Because aircraft interior structures must meet stringent FAA requirements for strength, maintaining the high-quality standards required for structural integrity is a production challenge. Moreover, such aircraft interior structures with mortise-and-tenon construction cannot be dissembled and sandwich panels cannot be easily replaced. Accordingly, discovery of quality issues after construction or installation of aircraft interior structures may require significant rework and scrapping of expensive components.

### SUMMARY

Bracket kits for coupling a first panel to a second panel at an angle comprise an exterior bracket and an interior bracket. The exterior bracket has an exterior-bracket first wall having an exterior-bracket first-wall inner face and an exterior-bracket first-wall outer face opposite the exterior-bracket first-wall inner face, an exterior-bracket second wall having an exterior-bracket second-wall inner face and an exterior-bracket second-wall outer face opposite the exterior-bracket second-wall inner face, and a first projection extending from the exterior-bracket first-wall inner face. The exterior-bracket second-wall inner face extends at the angle to the exterior-bracket first-wall inner face, and the exterior-bracket second wall defines an exterior-bracket second-wall fastener hole extending through the exterior-bracket second wall along a first axis. The first projection defines a first-projection fastener hole extending through the first projection along a second axis. The interior bracket has an interior-bracket first wall having an interior-bracket first-wall inner face and an interior-bracket first-wall outer face opposite the interior-bracket first-wall inner face, an interior-bracket second wall having an interior-bracket second-wall inner face and an interior-bracket second-wall outer face opposite the interior-bracket second-wall inner face, and a second projection extending from the interior-bracket second-wall outer face. The interior-bracket second-wall inner face extends at the angle to the exterior-bracket first-wall inner face, and the interior-bracket first wall defines an interior-bracket first-wall fastener hole extending through the interior-bracket first wall along the second axis. The second projection defines a second-projection fastener hole extending through the second projection along the first axis. Methods of manufacturing the bracket kit comprise injection-molding each of the exterior bracket and the interior bracket.

Assemblies comprise the bracket kit, a first panel, a second panel, a first male fastener, and a second male fastener. The first panel is engaged with the exterior-bracket first-wall inner face. The first panel defines a first-panel projection slot, through which the first projection extends. The second panel is engaged with the interior-bracket second-wall inner face. The second panel defines a second-panel projection slot through which the second projection extends. The first male fastener extends through the first-projection fastener hole and the interior-bracket first-wall fastener hole. The second male fastener extends through the second-projection fastener hole and the exterior-bracket second-wall fastener hole.

Methods of assembling the assembly comprise inserting the first projection through the first-panel projection slot such that the first panel engages the exterior-bracket first-wall inner face, inserting the second projection through the second-panel projection slot such that the second panel engages the interior-bracket second-wall outer face, inserting the first male fastener through the first-projection fastener hole and securing the first male fastener in place, and inserting the second male fastener through the second-projection fastener hole and securing the second male fastener in place.

Methods of thermoforming a bracket comprise placing a bracket defined by a first angle between a heat and pressure-applying male mold and a female mold, the molds defining a second angle, applying pressure and heating the bracket through a softening point such that the bracket is defined by the second angle, removing heat from the bracket, and removing pressure responsive to the bracket cooling below the softening point.

### BRIEF DESCRIPTION OF THE DRAWINGS

FIG. 1 is an illustration of an example aircraft.

FIG. 2 is an illustration of an example aircraft interior.

FIG. 3 is a schematic illustration representing brackets and assemblies according to the present disclosure.

FIG. 4 is a schematic illustration representing hollow projections of brackets according to the present disclosure.

FIG. 5 is an isometric view of an example bracket according to the present disclosure.

FIG. 6 is a front view of the example bracket of FIG. 5.

FIG. 7 is a rear view of the example bracket of FIG. 5.

FIG. 8 is a top view of the example bracket of FIG. 5.

FIG. 9 is a bottom view of the example bracket of FIG. 5.

FIG. 10 is a side view of the example bracket of FIG. 5.

FIG. 11 is an exploded isometric view of an example assembly with the example bracket of FIG. 5.

FIG. 12 is an isometric view of the example assembly of FIG. 11.

FIG. 13 is an isometric view of another example bracket according to the present disclosure.

FIG. 14 is a front view of the example bracket of FIG. 13.

FIG. 15 is a rear view of the example bracket of FIG. 13.

FIG. 16 is a top view of the example bracket of FIG. 13.

FIG. 17 is a bottom view of the example bracket of FIG. 13.

FIG. 18 is a side view of the example bracket of FIG. 13.

FIG. 19 is a schematic illustration representing bracket kits and assemblies according to the present disclosure.

FIG. 20 is a schematic illustration representing bracket kits according to the present disclosure.

FIG. 21 is an isometric view of an example bracket of a bracket kit according to the present disclosure.

FIG. 22 is an additional view of the example bracket of FIG. 21.

FIG. 23 is an isometric view of an example bracket of a bracket kit according to the present disclosure.

FIG. 24 is an additional view of the example bracket of FIG. 23.

FIG. 25 is an exploded view of an example assembly with the example bracket kit of FIGS. 21–24.

FIG. 26 is an isometric view of the example assembly of FIG. 25.

FIG. 27 is an isometric view of another example bracket of a bracket kit according to the present disclosure.

FIG. 28 is an additional view of the example bracket of FIG. 27.

FIG. 29 is an isometric view of another example bracket of a bracket kit according to the present disclosure.

FIG. 30 is an additional view of the example bracket of FIG. 29.

FIG. 31 is an exploded view of another example assembly with the example bracket kit of FIGS. 27–30.

FIG. 32 is an isometric view of the example assembly of FIG. 31.

FIG. 33 is a flowchart schematically representing methods according to the present disclosure.

FIG. 34 is a flowchart schematically representing additional methods according to the present disclosure.

FIGS. 35A, 35B, and 35C schematically represent an example sequence according to methods of FIG. 34.

### DESCRIPTION

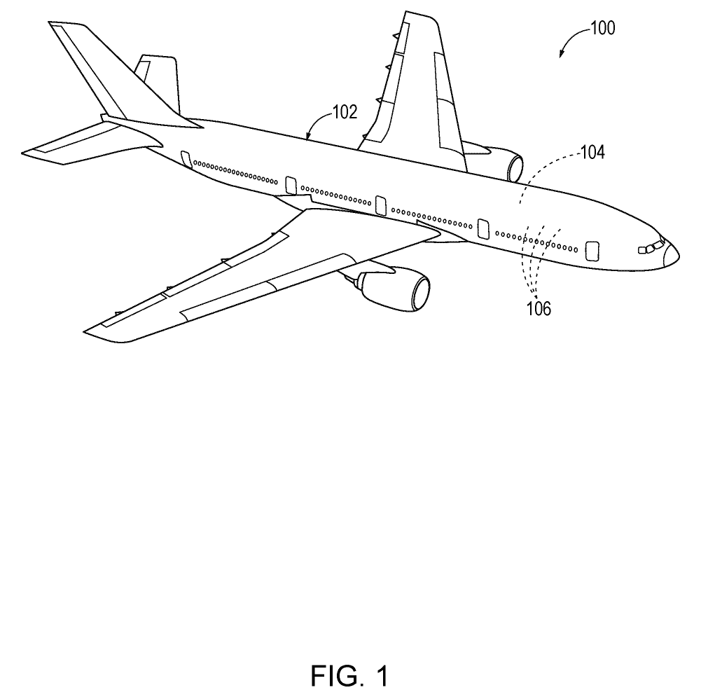

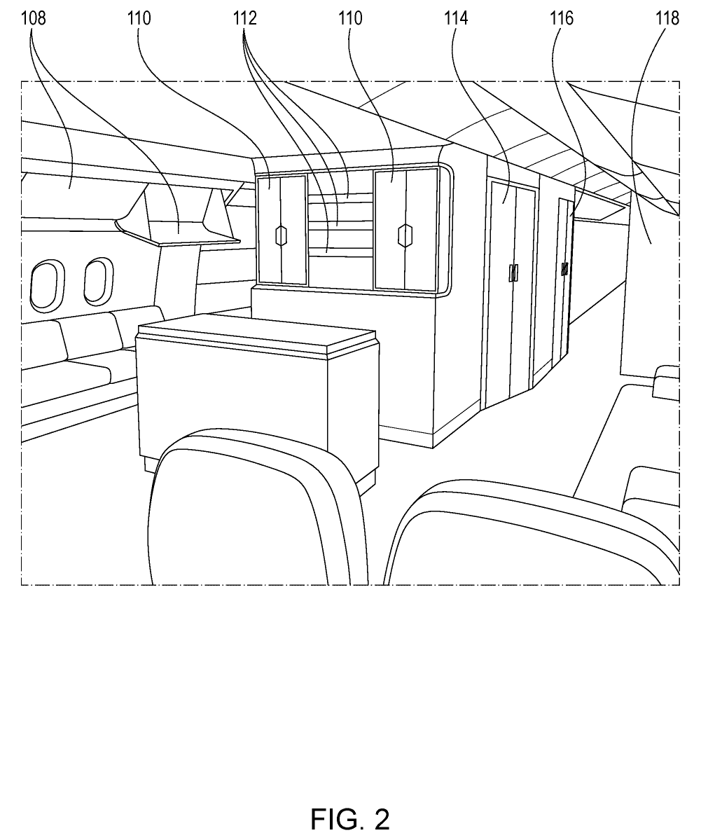

With initial reference to FIG. 1, aircraft 100 according to the present disclosure comprise a fuselage 102 that defines an interior 104 and typically one or more aerospace assemblies 106 positioned within the interior 104. FIG. 2 illustrates an example interior 104 with various example aerospace assemblies 106 including aircraft stowage bins 108, aircraft closets or cabinets 110, an aircraft shelving unit 112, an aircraft crew rest compartment 114, an aircraft lavatory 116, and an aircraft interior bulkhead 118. One or more of such aerospace assemblies 106 of an aircraft 100 may comprise an assembly 62 according to the present disclosure that comprises one or more brackets 10 according to the present disclosure.

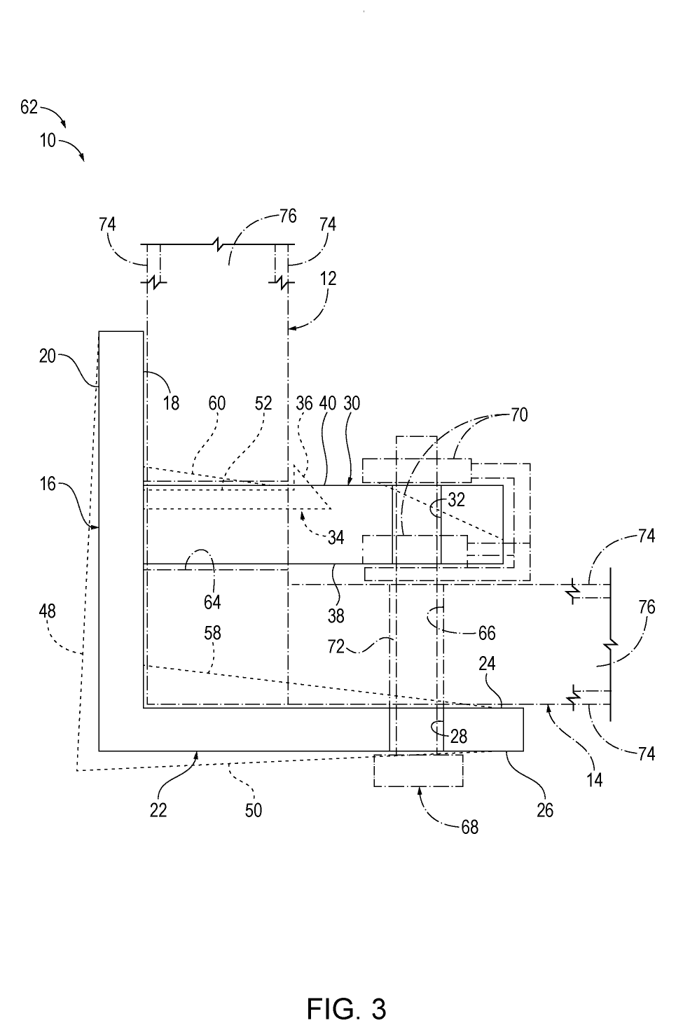

FIGS. 3 and 4 schematically represent brackets 10 and assemblies 62 according to the present disclosure. Generally, in FIGS. 3 and 4, elements that are likely to be included in a given example are illustrated in solid lines, while elements that are optional to a given example or that correspond to one or more specific examples are illustrated in broken lines. However, elements that are illustrated in solid lines are not essential to all examples of the present disclosure, and an element shown in solid lines may be omitted from a particular example without departing from the scope of the present disclosure.

With reference to FIG. 3, brackets 10 for coupling a first panel 12 to a second panel 14 at an angle. In some examples, the angle is a right angle. Herein, a right angle is an angle of 90° or approximately 90°, such as within typical manufacturing tolerances for brackets 10. In some assemblies 62, the first panel 12 and the second panel 14 are sandwich panels, such as each comprising opposing face sheets 74 and a honeycomb core 76.

As schematically represented in FIG. 3, brackets 10 comprise a first wall 16, a second wall 22, and a hollow projection 30. The first wall 16 has a first-wall inner face 18 and a first-wall outer face 20 that is opposite the first-wall inner face 18. The second wall 22 has a second-wall inner face 24 and a second-wall outer face 26 opposite the second-wall inner face 24. The second-wall inner face 24 extends at the angle to the first-wall inner face 18, and the second wall 22 defines a second-wall fastener hole 28 that extends through the second wall 22. The hollow projection 30 extends from the first-wall inner face 18 and defines a projection fastener hole 32 that extends through the hollow projection 30 and that is co-axially aligned with the second-wall fastener hole 28.

Assemblies 62 comprise the bracket 10, the first panel 12, the second panel 14, and a male fastener 68 (e.g., a bolt or other threaded male fastener). In FIG. 3, the first panel 12, the second panel 14, and the male fastener 68 are schematically represented in dash-dot lines as environment to the bracket 10. However, in assemblies 62, the first panel 12, the second panel 14, and the male fastener 68 are present. In assemblies 62, the first panel 12 is engaged with the first-wall inner face 18 of the bracket 10. In assemblies 62, the first panel 12 defines a first-panel projection slot 64, through which the hollow projection 30 of the bracket 10 extends. In assemblies 62, the second panel 14 is engaged with the second-wall inner face 24 of the bracket 10. In assemblies 62, the second panel 14 defines a second-panel fastener hole 66 that is co-axially aligned with the second-wall fastener hole 28 and with the projection fastener hole 32. In assemblies 62, the male fastener 68 extends through the second-wall fastener hole 28, the second-panel fastener hole 66, and the projection fastener hole 32. In some examples, assemblies 62 further comprise a female fastener 70, such as a nut, a nut clip, a barrel nut, a captive nut, or an ultrasonic insert that operatively mates with the male fastener 68. Some assemblies 62 further comprise a bushing 72 that is positioned within the second-panel fastener hole 66, with the male fastener 68 extending therethrough. When present, the bushing 72 may protect the integrity of the surface(s) of the second panel 14 that defines the second-panel fastener hole 66.

Methods of assembling assemblies 62 comprise inserting the hollow projection 30 of the bracket 10 through the first-panel projection slot 64 such that the first panel 12 engages the first-wall inner face 18, engaging the second panel 14 with the second-wall inner face 24 of the bracket 10 and with the first panel 12, inserting the male fastener 68 through the second-wall fastener hole 28, the second-panel fastener hole 66, and the projection fastener hole 32, and securing the male fastener 68 in place.

Accordingly, the hollow projection 30 of brackets 10 provides structure transferring shear and moment loads from the second panel 14 to the first panel 12, thereby operatively maintaining the first panel 12 in relation to the second panel 14. Moreover, the hollow projection 30 provides structure for the male fastener 68 to operatively secure the second panel 14 in place. Therefore, when brackets 10 are manufactured within desired tolerances, brackets 10 provide for secure assembly of the first panel 12 and the second panel 14 within an assembly 62 without the need for liquid adhesives.

As schematically represented in FIG. 3, some brackets 10 further comprise a cantilever clip 34 that extends away from the first-wall inner face 18 and that is configured to interface with the first panel 12 for operatively maintaining the first panel 12 in engagement with the first-wall inner face 18 of the bracket 10. In some examples, the cantilever clip 34 comprises a hook 36 that extends away from the second-wall inner face 24 for operative engagement with the first panel 12. The hook 36 additionally or alternatively may be described as a barb 36, and the cantilever clip 34 may be described as having a snap-fit arrangement with the first panel 12. That is, in some assemblies 62, the hook 36 engages the first panel 12 opposite the first-wall inner face 18.

The hollow projection 30 is hollow, such as constructed from a thin wall of material. Accordingly, the hollow projection 30 provides a higher strength-to-mass ratio than an otherwise solid projection of the same mass.

The hollow projection 30 may be described as having a projection profile when viewed from its end (i.e., when facing the first-wall inner face 18). Similarly, in assemblies 62, the first-panel projection slot 64 through which the hollow projection 30 extends may be described as having a projection-hole profile that is concentric with the projection profile. In some examples of assemblies 62, the hollow projection 30 is in a slip-fit arrangement (i.e., in close proximity and engaged) with the surface or surfaces of the first panel 12 that define the first-panel projection slot 64. In some examples of assemblies 62, the hollow projection 30 is in a friction-fit arrangement (i.e., tight fit) with the surface or surfaces of the first panel 12 that define the first-panel projection slot 64. Accordingly, in such examples, the hollow projection 30 serves to operatively maintain the first panel 12 in a fixed position relative to the bracket 10.

With reference to FIG. 4, in some examples, the hollow projection 30 comprises a projection lower face 38 that faces the second-wall inner face 24, a projection upper face 40 that is opposite the projection lower face 38 and that faces away from the second-wall inner face 24, a projection left face 42 that extends between the projection lower face 38 and the projection upper face 40, and a projection right face 44 that is opposite the projection left face 42 and that extends between the projection lower face 38 and the projection upper face 40. Accordingly, the hollow projection 30 may be described as having a generally quadrilateral profile. In some examples, the hollow projection 30 has a generally trapezoidal profile, and in some examples, it has a generally isosceles trapezoidal profile. By generally quadrilateral or trapezoidal, it is meant that the profile of the hollow projection 30 may not be a perfect polygon with sharp edges and/or perfectly planar walls. Rather, the edges of the projection (i.e., the corners of the profile) may be curved or rounded, and the faces of the projection may not be uniform or otherwise extend across an entirety of a side of the projection.

With continued reference to FIG. 4, the projection lower face 38 may be described as having a lower-face width 46, and the projection upper face 40 may be described as having an upper-face width 49. In some examples, the lower-face width 46 is less than the upper-face width 49. In such examples, in assemblies 62, the load transfer from the hollow projection 30 to the first panel 12 will be concentrated away from the edge of the first panel 12. Moreover, the large area of the hollow projection 30 in contact with the first-panel projection slot 64 lowers the bearing stress in the face sheets 74, thereby enabling effective transfer or shear and moment forces.

With continued reference to FIG. 4, in some examples, the projection upper face 40 defines a gap 54, and the cantilever clip 34 extends within the gap 54. Accordingly, in such examples, the cantilever clip 34 is positioned to operatively engage the first panel 12 opposite the first-wall inner face 18. The cantilever clip 34 may be described as having a cantilever-clip upper face 52, and in some examples, as schematically represented in FIG. 3, the cantilever-clip upper face 52 is co-planar with and/or parallel to the projection upper face 40. Accordingly, in examples that include a hook 36, the hook need not be very long, thereby reducing the force required to insert the hollow projection 30 into and through the first-panel projection slot 64 and decreasing the opportunity for the hook 36 to break.

As schematically represented in dashed lines in FIG. 3, in some examples, the projection lower face 38 extends further from the first-wall inner face 18 than the projection upper face 40. In some such examples, the projection fastener hole 32 extends through the projection lower face 38 but not through the projection upper face 40. Accordingly, in such examples, access to the male fastener 68 with the female fastener 70 is facilitated. In addition, less material is utilized, thereby reducing the mass of the bracket 10.

With continued reference to FIG. 3, in some examples, brackets 10 further comprise one or more first-wall reinforcing ribs 48 that extend from the first-wall outer face 20 and/or one or more second-wall reinforcing ribs 50 extending from the second-wall outer face 26. As implied, when present, the reinforcing ribs stiffen the bracket 10. In some examples, the one or more second-wall reinforcing ribs 50 are coextensive with the one or more first-wall reinforcing ribs 48, such as being integral with each other at the corner of the bracket 10 where the first wall 16 and the second wall 22 meet. In some examples, as schematically illustrated in FIG. 3, the reinforcing ribs taper away from the corner of the bracket 10.

In some examples, brackets 10 further comprise one or more second-wall piercing ribs 58 that extend from the second-wall inner face 24 perpendicular to the first-wall inner face 18 and that taper away from the first-wall inner face 18. For example, the second-wall piercing rib(s) 58 may have a triangular or generally triangular cross-sectional profile. As a result, in assemblies 62, these second-wall piercing rib(s) 58 cut into, bite into, or otherwise extend into at least the edge of the first panel 12 and, when extending beyond the first panel 12, also into the face of the second panel 14 that engages the second-wall inner face 24. As a result, these second-wall piercing rib(s) 58 serve to restrict sliding and rotational movement of the first panel 12 and/or the second panel 14 across the second-wall inner face 24.

Similarly, in some examples, as also schematically represented in FIG. 3, brackets 10 further comprise one or more projection piercing ribs 60 that extend away from the hollow projection 30 perpendicular to the first-wall inner face 18 and that taper away from the first-wall inner face 18. As with the second-wall piercing rib(s) 58, the projection piercing rib(s) 60 may have a triangular or generally triangular cross-sectional profile. As a result, in assemblies 62, these projection piercing rib(s) 60 cut into, bite into, or otherwise extend into the surface(s) of the first panel 12 that define the first-panel projection slot 64. As a result, the projection piercing rib(s) 60 serve to restrict the first panel 12 from rotating, or otherwise moving, relative to the hollow projection 30 and thus the first wall 16. As schematically representing in FIG. 4, in some examples, the projection piercing rib(s) 60 extend from the projection upper face 40; however, projection piercing rib(s) 60 additionally or alternatively may extend from any outer surface of the hollow projection 30.

In some examples, the bracket 10 is monolithic. That is, the bracket 10 may be constructed as a single piece of material, as opposed to being an assembly of more than one piece of material. As examples, brackets 10 may be manufactured by injection-molding. Typically, brackets 10 are constructed of plastic, but they also may be constructed of composite material, such as fiber glass or other fiber-reinforced plastic material, or they may be constructed of metal, such as aluminum.

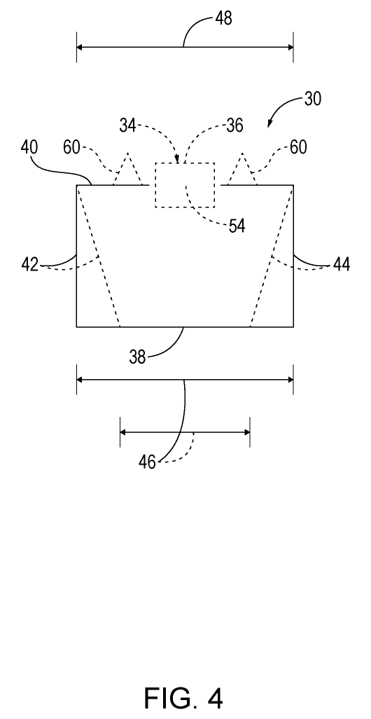

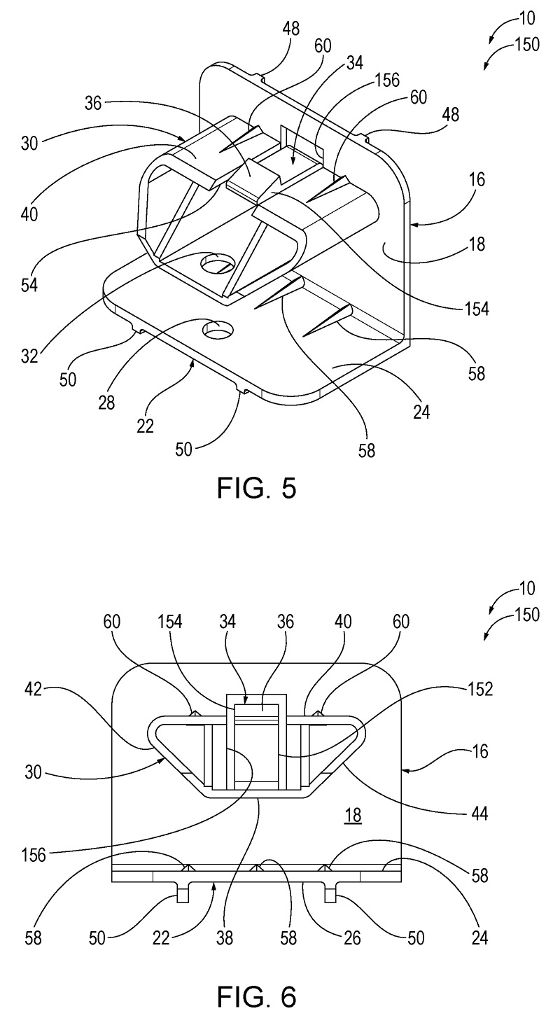

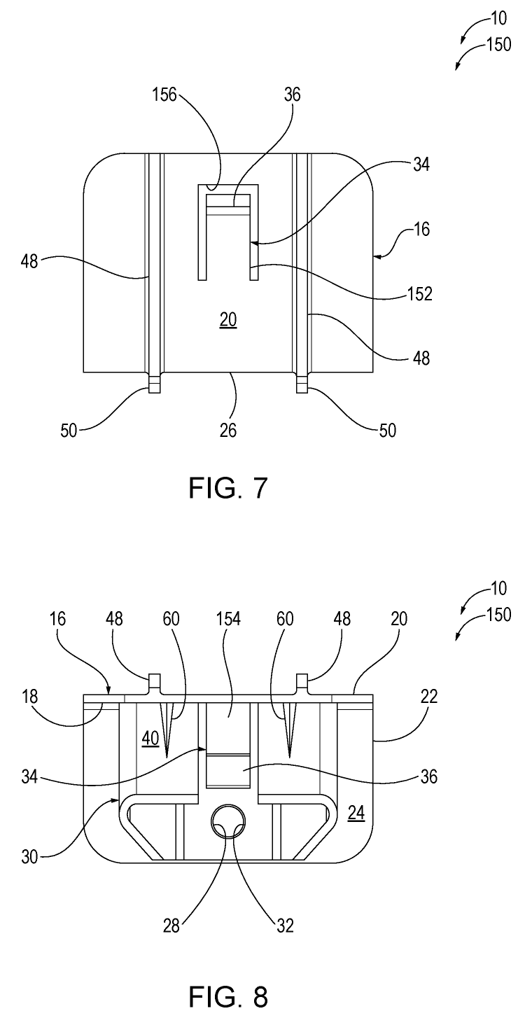

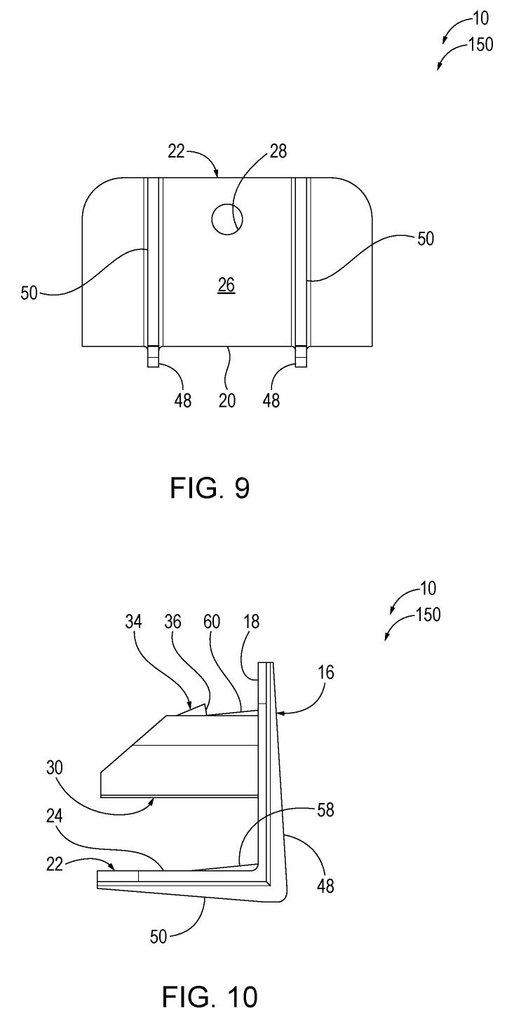

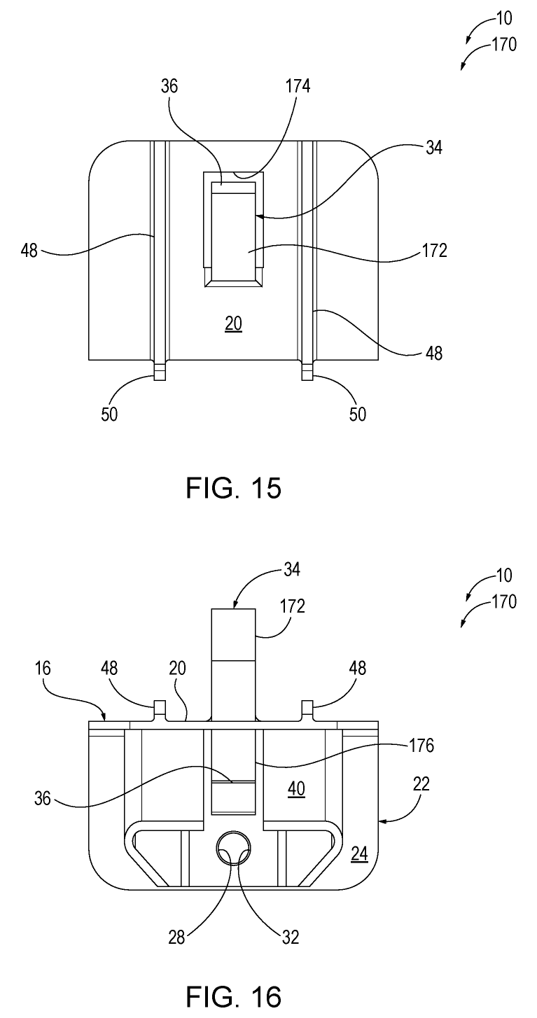

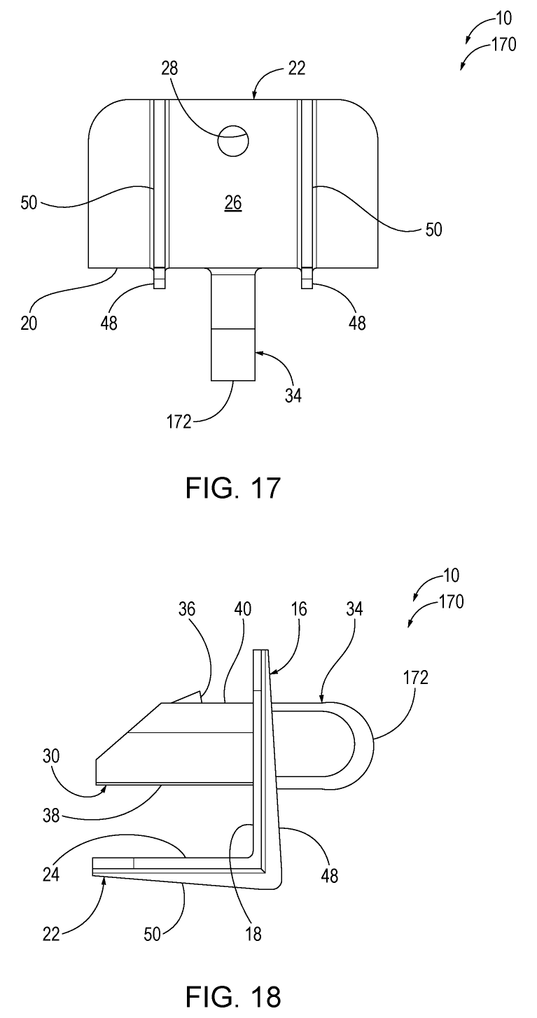

Turning now to FIGS. 5–18, illustrative non-exclusive examples of brackets 10 and assemblies 62 are illustrated. Where appropriate, the reference numerals from the schematic illustrations of FIGS. 3 and 4 are used to designate corresponding parts of the examples of FIGS. 5–18; however, the examples of FIGS. 5–18 are non-exclusive and do not limit brackets 10 and assemblies 62 to the illustrated examples. That is, brackets 10 and assemblies 62 are not limited to the specific embodiments of FIGS. 5–18, and brackets 10 and assemblies 62 may incorporate any number of the various aspects, configurations, characteristics, properties, etc. of brackets 10 and assemblies 62 that are illustrated in and discussed with reference to the schematic representations of FIGS. 3 and 4 and/or the embodiments of FIGS. 5–18, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to the embodiments of FIGS. 5–18; however, it is within the scope of the present disclosure that the previously discussed features, variants, etc. may be utilized with these embodiments.

FIGS. 5–10 illustrate a first example of a bracket 10, indicated at 150. Bracket 150 is an example of a monolithic bracket 10, whose first-wall inner face 18 is at a right angle to the second-wall inner face 24. Bracket 150 comprises a hollow projection 30 having a generally isosceles trapezoidal profile with a lower-face width that is than the upper-face width, and with a projection lower face 38 that extends further from the first-wall inner face 18 than a projection upper face 40. The projection fastener hole 32 extends through the projection lower face 38 but not through the projection upper face 40. In addition, the projection upper face 40 defines a gap 54, and bracket 150 comprises a cantilever clip 34 that has a hook 36 and that extends within the gap 54. The cantilever clip 34 of bracket 150 has a proximal portion 152 that extends along a passage 156 in the first wall 16 and is co-planar with the first wall 16 and a distal portion 154 that extends away from the proximal portion 152 within the gap 54 of the hollow projection 30. Bracket 150 comprises two first-wall reinforcing ribs 48 and two second-wall reinforcing ribs 50 that are coextensive with each other. Bracket 150 also comprises three second-wall piercing ribs 58 and two projection piercing ribs 60.

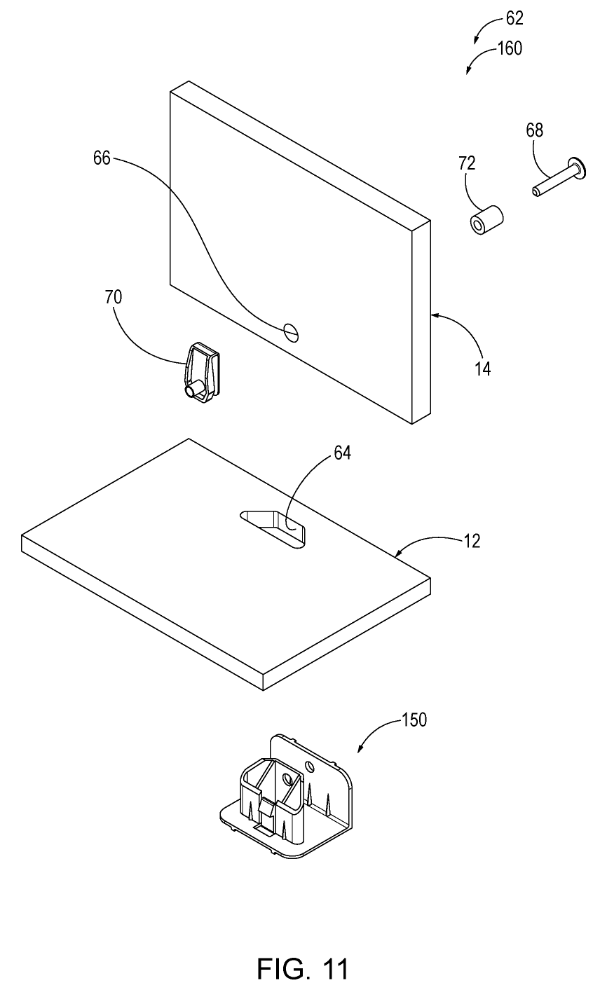

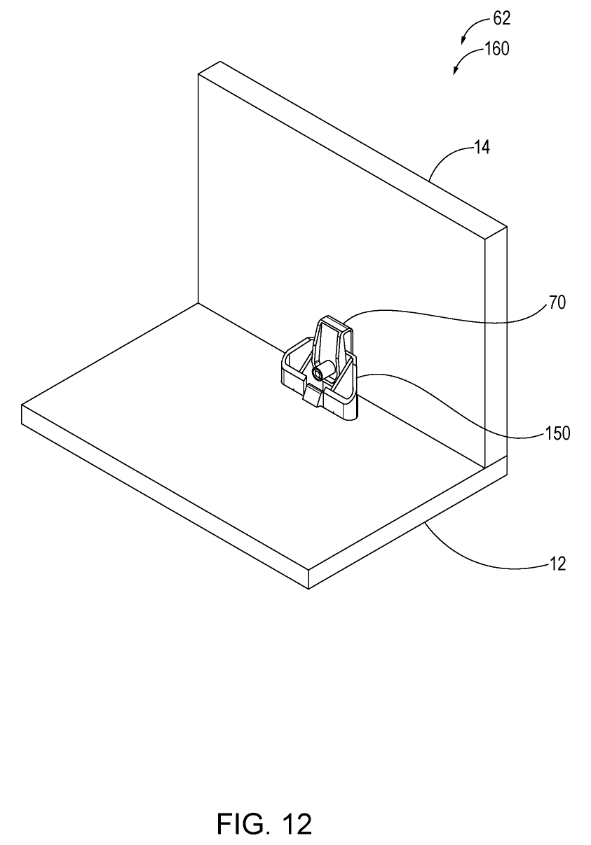

FIGS. 11 and 12 illustrate an example of an assembly 62, indicated at 160. Assembly 160 comprises bracket 150, a first panel 12, a second panel 14, a male fastener 68 in the form of a bolt, a bushing 72, and a female fastener 70 in the form of a nut clip. The nut clip extends on opposing sides of the lower wall of the hollow projection 30, positioning the female threaded portion of the nut clip for operative engagement with the male fastener 68.

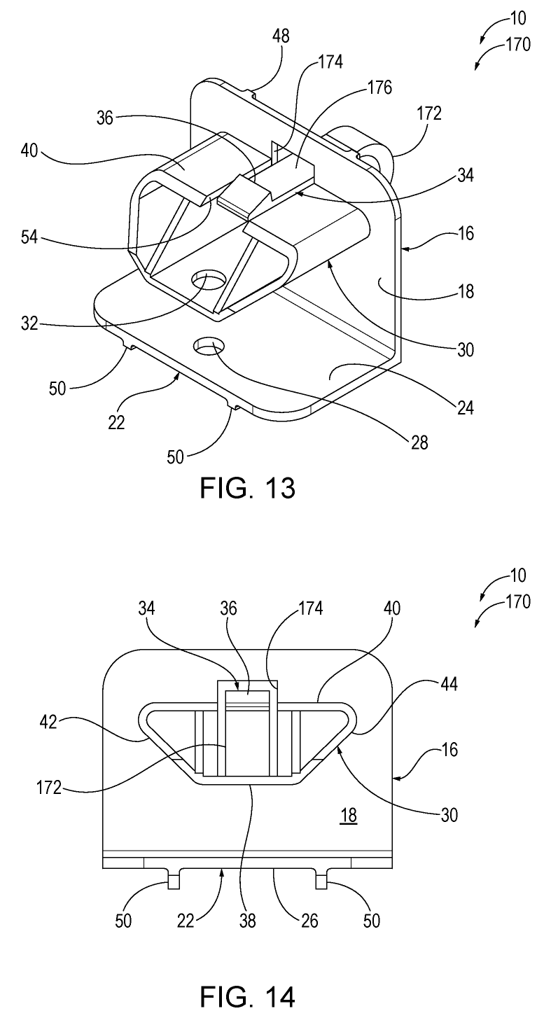

FIGS. 13–18 illustrate a second example of a bracket 10 indicted at 170. Bracket 170 is constructed similarly to bracket 150 of FIGS. 5–12; however, in bracket 170, the cantilever clip 34 has a proximal portion 172 that extends from the first-wall outer face 20 and curves back through a passage 174 defined in the first wall 16 where a distal portion 176 of the cantilever clip 34 then extends within the gap 54 of the hollow projection 30.

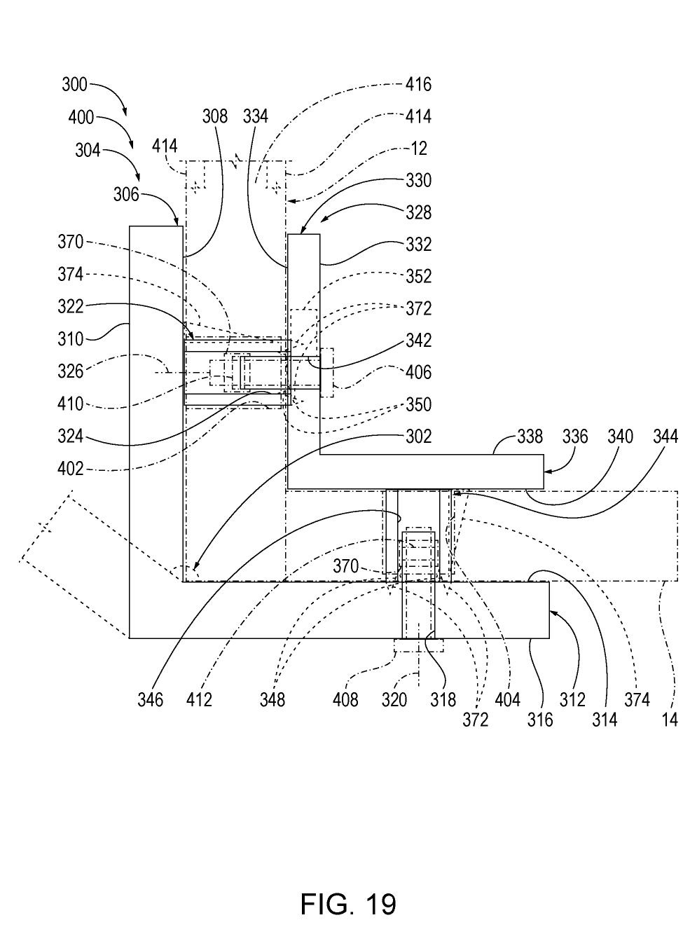

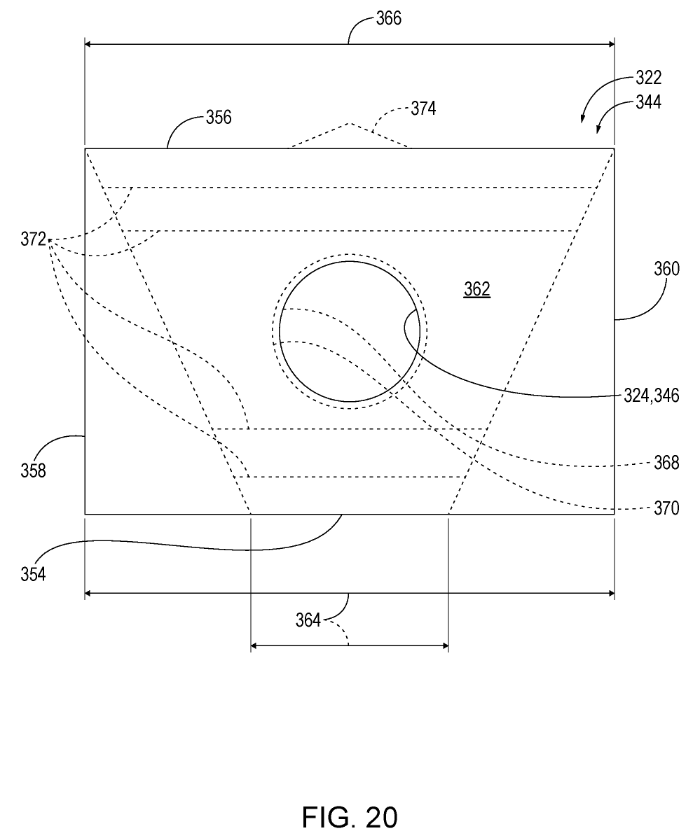

FIGS. 19 and 20 schematically represent bracket kits 300 and assemblies 400 according to the present disclosure. Generally, in FIGS. 19 and 20, elements that are likely to be included in a given example are illustrated in solid lines, while elements that are optional to a given example or that correspond to one or more specific examples are illustrated in broken lines. However, elements that are illustrated in solid lines are not essential to all examples of the present disclosure, and an element shown in solid lines may be omitted from a particular example without departing from the scope of the present disclosure.

With reference to FIG. 19, bracket kits 300 for coupling the first panel 12 to the second panel 14 at an angle 302. In some examples, the angle 302 is a right angle. Herein, a right angle is an angle of 90° or approximately 90°, such as within typical manufacturing tolerances for brackets. In some further examples, the angle 302 is an obtuse angle. Herein, an obtuse angle is an angle greater than 90° and less than 180°. In some assemblies 400, the first panel 12 and the second panel 14 are sandwich panels, such as each comprising opposing face sheets 414 and a honeycomb core 416.

As schematically represented in FIG. 19, bracket kits 300 comprise an exterior bracket 304 and an interior bracket 328. The exterior bracket 304 comprises an exterior-bracket first wall 306, an exterior-bracket second wall 312, and a first projection 322. The exterior-bracket second wall 312 defines an exterior-bracket second-wall fastener hole 318, which extends through the exterior-bracket second wall 312 along a first axis 320. The exterior-bracket first wall 306 has an exterior-bracket first-wall inner face 308 and an exterior-bracket first-wall outer face 310 opposite the exterior-bracket first-wall inner face 308. Similarly, the exterior-bracket second wall 312 has an exterior-bracket second-wall inner face 314 and an exterior-bracket second-wall outer face 316 opposite the exterior-bracket second-wall inner face 314. Accordingly, the exterior-bracket second-wall inner face 314 extends at the angle 302 to the exterior-bracket first-wall inner face 308. Additionally, the first projection 322 extends from the exterior-bracket first-wall inner face 308 and defines a first-projection fastener hole 324 which extends through the first projection 322 along a second axis 326.

The interior bracket 328 comprises an interior-bracket first wall 330, an interior-bracket second wall 336, and a second projection 344. The interior-bracket first wall 330 defines an interior-bracket first-wall fastener hole 342, which extends through the interior-bracket first wall 330 along the second axis 326. The interior-bracket first wall 330 has an interior-bracket first-wall inner face 332 and an interior-bracket first-wall outer face 334 opposite the interior-bracket first-wall inner face 332. Similarly, the interior-bracket second wall 336 has an interior-bracket second-wall inner face 338 and an interior-bracket second-wall outer face 340 opposite the interior-bracket second-wall inner face 338. Accordingly, the interior-bracket second-wall outer face 340 extends at the angle 302 to the interior-bracket first-wall outer face 334. Additionally, the second projection 344 extends from the interior-bracket second-wall outer face 340 and defines a second-projection fastener hole 346, which extends through the second projection 344 along the first axis 320.

With further reference to FIG. 19, when the bracket kit 300 is operatively positioned relative to the first panel 12 and the second panel 14, the first projection 322 extends through the first panel 12 and the second projection 344 extends through the second panel 14.

Assemblies 400 comprise the bracket kit 300, the first panel 12, the second panel 14, a first male fastener 406, and a second male fastener 408 (e.g., a bolt or other threaded male fastener). In FIG. 19, the first panel 12, the second panel 14, the first male fastener 406, and the second male fastener 408 are schematically represented in dash-dot lines as environment to the bracket kit 300. However, in assemblies 400, the first panel 12, the second panel 14, the first male fastener 406, and the second male fastener 408 are present. In assemblies 400, the first panel 12 is engaged with the exterior-bracket first-wall inner face 308, and the first panel 12 defines a first-panel projection slot 402, through which the first projection 322 of the exterior bracket 304 extends. Similarly, the second panel 14 is engaged with the interior-bracket second-wall outer face 340, and the second panel 14 defines a second-panel projection slot 404, through which the second projection 344 of the interior bracket 328 extends. The first male fastener 406 extends through the first-projection fastener hole 324 and the interior-bracket first-wall fastener hole 342, and the second male fastener 408 extends through the second-projection fastener hole 346 and the exterior-bracket second-wall fastener hole 318.

In some examples, assemblies 400 further comprise a first female fastener 410 that operatively mates with the first male fastener 406, and a second female fastener 412 that operatively mates with the second male fastener 408. Examples of suitable female fasteners include a nut, a nut clip, a barrel nut, a captive nut, or an ultrasonic insert. In some examples, when the first projection 322 includes a fastener hold 370, the first female fastener 410 is retained by the fastener hold 370 and the first male fastener 406 extends through the fastener hold 370. Similarly, when the second projection 344 includes a fastener hold 370, the second female fastener 412 is retained by the fastener hold 370 and the second male fastener 408 extends through the fastener hold 370. When present, the fastener holds 370 may protect the integrity of the surface(s) of the respective first-projection fastener hole 324 and the second-projection fastener hole 346 when operatively installing male fasteners. Additionally, the fastener holds 370 may prevent slippage of male fasteners and/or female fasteners during assembling.

Accordingly, the first projection 322 and the second projection 344 provide sufficient structure for transferring shear and moment loads from the second panel 14 to the first panel 12 and from the first panel 12 to the second panel 14, thereby operatively maintaining the first panel 12 in relation to the second panel 14. Moreover, each of the first projection 322 and the second projection 344 provide structure to receive respective male fasteners 406 and 408 to operatively secure the first panel 12 and the second panel 14 in place. Therefore, when bracket kits 300 are manufactured within desired tolerances, bracket kits 300 provide for secure assembly of the first panel 12 and the second panel 14 within assemblies 400 without the need for liquid adhesives.

With continued reference to FIG. 19, in some bracket kits 300, a portion of the exterior-bracket second-wall inner face 314 includes a plurality of exterior-bracket ridges 348. In some such examples, the exterior-bracket ridges 348 are disposed around the exterior-bracket second-wall fastener hole 318. Similarly, in some examples, a portion of the interior-bracket first-wall outer face 334 in some interior brackets 328 have a plurality of interior-bracket ridges 350. In some such examples, the interior-bracket ridges 350 are disposed around the interior-bracket first-wall fastener hole 342. The addition of ridges to exterior brackets 304 and/or interior brackets 328 may aid in positioning the first panel 12 relative to exterior brackets 304 and interior brackets 328 and/or the second panel 14 relative to exterior brackets 304 and interior brackets 328. Additionally, ridges increase a coefficient of friction between the surface(s), decreasing slipping when assemblies 400 are subject to joint bending loads. In such assemblies 400, the ridged brackets also help distribute load across contact surface(s) to prevent localized loads.

In some bracket kits 300, the interior-bracket first-wall fastener hole 342 also extends along the interior-bracket first wall 330 perpendicular to the second axis 326, defining an elongate channel 352. In such examples, the elongate channel 352 may aid in positioning the first male fastener 406, accounting for potential deviations in the exact position of the first-projection fastener hole 324 relative to the interior-bracket first-wall fastener hole 342 and the first-projection fastener hole 324. In particular, as discussed herein with respect to methods 600, brackets of a bracket kit 300 may be modified from having an angle 302 of 90° to having an angle 302 greater than 90°. With the interior-bracket first-wall fastener hole 342 defining an elongate channel 352, alignment with the first-projection fastener hole 324 will be ensured for a range of angles 302.

In some bracket kits 300, each of the first projection 322 and the second projection 344 may be described as having a projection profile when viewed from its end (i.e., when facing the exterior-bracket first-wall inner face 308 and the interior-bracket second-wall outer face 340 respectively). Similarly, in some assemblies 400, the first-panel projection slot 402 through which the first projection 322 extends may be described as having a projection-hole profile that is concentric with the projection profile of the first projection 322. Additionally, in such assemblies 400, the second-panel projection slot 404 through which the second projection 344 extends may be described as having a projection-hole profile that is concentric with the projection profile of the second projection 344. In some examples, each of the first projection 322 and the second projection 344 is in a slip-fit arrangement (i.e., in close proximity and engaged) with the surface or surfaces of the first panel 12 and the second panel 14 respectively, that each define the first-panel projection slot 402 and the second-panel projection slot 404 respectively. In other examples of assemblies 400, each of the first projection 322 and the second projection 344 is in a friction-fit arrangement (i.e., tight fit) with the surface or surfaces of the first panel 12 and the second panel 14 respectively, that each define the first-panel projection slot 402 and the second-panel projection slot 404 respectively. Accordingly, the first projection 322 serves to operatively maintain the first panel 12 in a fixed position relative to the exterior bracket 304, and the second projection 344 serves to operatively maintain the second panel 14 in a fixed position relative to the interior bracket 328.

In some further examples, each of the first projection 322 and the second projection 344 is hollow, such as constructed from a thin wall of material. Accordingly, when each of the first projection 322 and the second projection 344 is made hollow this may provide a higher strength-to-mass ratio than an otherwise solid projection of the same mass.

With reference to FIG. 20, in some bracket kits 300, each of the first projection 322 and the second projection 344 comprises a projection lower face 354, a projection upper face 356 that is opposite the projection lower face 354, a projection left face 358 that extends between the projection lower face 354 and the projection upper face 356, a projection right face 360 opposite the projection left face 358 that extends between the projection lower face 354 and the projection upper face 356, and a projection front face 362 that extends between the projection lower face 354, the projection upper face 356, the projection left face 358, and the projection right face 360. In some such examples, the first-projection fastener hole 324 extends through the projection front face 362 of the first projection 322. Additionally, in such examples, the second-projection fastener hole 346 extends through the projection front face 362 of the second projection 344. Accordingly, each of the first projection 322 and the second projection 344 may be described as having a generally quadrilateral profile. In some examples, each of the first projection 322 and the second projection 344 has a generally trapezoidal profile, and in some examples, a generally isosceles trapezoidal profile. By generally quadrilateral or trapezoidal, it is meant that the profile of each of the first projection 322 and the second projection 344 may not be a perfect polygon with sharp edges and/or perfectly planar walls. Rather, the edges of each of the first projection 322 and second projection 344 (i.e., the corners of the profile) may be curved or rounded, and the faces of the projections may not be uniform or otherwise extend across an entirety of a side of the projections.

With continued reference to FIG. 20, the projection lower face 354 may be described as having a lower-face width 364, and the projection upper face 356 may be described as having an upper-face width 366. In some examples, the lower-face width 364 is less than the upper-face width 366. In such examples, in assemblies 400, the load transfer from the first projection 322 to the first panel 12 will be concentrated away from the edge of the first panel 12, and the load transfer from the second projection 344 to the second panel 14 will be concentrated away from the edge of the second panel 14. Moreover, the large area of the first projection 322 in contact with the first-panel projection slot 402 and the large area of the second projection 344 in contact with the second-panel projection slot 404 lowers the bearing stress at each of the respective interfaces.

In some bracket kits 300, each of the first projection 322 and the second projection 344 further comprises a projection rear face 368 opposite the projection front face 362. In some such examples, each of the first projection 322 and the second projection 344 comprises a fastener hold 370 disposed on the projection rear face 368.

In some bracket kits 300, the projection lower face 354 of the first projection 322 faces the exterior-bracket second-wall inner face 314 when operatively positioned relative to the first panel 12 and the second panel 14, the projection upper face 356 of the first projection 322 faces away from the exterior-bracket second-wall inner face 314 when operatively positioned relative to the first panel 12 and the second panel 14, and the projection front face 362 of the first projection 322 faces away from the exterior-bracket first-wall inner face 308 when operatively positioned relative to the first panel 12 and the second panel 14.

Additionally, the projection lower face 354 of the second projection 344 faces the interior-bracket first wall 330 when operatively positioned relative to the first panel 12 and the second panel 14, the projection upper face 356 of the second projection 344 faces away from the interior-bracket first wall 330 when operatively positioned relative to the first panel 12 and the second panel 14, and the projection front face 362 of the second projection 344 faces away from the interior-bracket second-wall outer face 340 when operatively positioned relative to the first panel 12 and the second panel 14.

With reference to FIGS. 19 and 20, in some bracket kits 300, a portion of the projection front face 362 comprises a plurality of projection ridges 372. In some such examples, the plurality of projection ridges 372 of the first projection 322 are disposed around the first-projection fastener hole 324. Accordingly, the plurality of projection ridges 372 of the second projection 344 are disposed around the second-projection fastener hole 346. The addition of projection ridges to the front face of projections improves interfacial contact between panels, brackets, and/or panels in assemblies 400 through mechanical interlock interactions. Additionally, projection ridges spread out the load distribution in assemblies 400.

With continued reference to FIGS. 19 and 20, in some bracket kits 300, each of the first projection 322 and the second projection 344 comprises a piercing rib 374. In some such examples, the piercing rib 374 of the first projection 322 extends and tapers away from the first projection 322 perpendicular to the exterior-bracket first-wall inner face 308. Similarly, the piercing rib 374 of the second projection 344 extends and tapers away from the second projection 344 perpendicular to the interior-bracket second-wall outer face 340 and tapers away from the interior-bracket second-wall outer face 340. The piercing ribs 374 may have a triangular or generally triangular cross-sectional profile. As a result, in assemblies 400, the piercing rib 374 of the first projection 322 cuts into, bites into, or otherwise extends into the surface(s) of the first panel 12 that define the first-panel projection slot 402. Similarly, in assemblies 400, the piercing rib 374 of the second projection 344 cuts into, bites into, or otherwise extends into the surface(s) of the second panel 14 that define the second-panel projection slot 404. As a result, the projection piercing ribs 374 serve to restrict the first panel 12 and the second panel 14 from rotating, or otherwise moving, relative to each of the first projection 322 and the second projection 344. As schematically represented in FIG. 20, in some examples, the piercing ribs 374 extend from the projection upper face 356; however, the piercing ribs 374 additionally or alternatively may extend from any outer surface of the projection.

In some bracket kits 300, each of the exterior bracket 304 and the interior bracket 328 is monolithic. That is, each of the exterior bracket 304 and the interior bracket 328 may be constructed as a single piece of material, as opposed to being an assembly of more than one piece of material. For example, bracket kits 300 may be manufactured by injection-molding. Typically, bracket kits 300 are constructed of plastic, but they also may be constructed of composite material, such as fiber glass or other fiber-reinforced plastic material, or they may be constructed of metal, such as aluminum.

In some examples, the exterior bracket 304 and the interior bracket 328 that comprise the bracket kit 300 may be injection-molded at a fixed angle, such as 90°. However, in some examples, when the exterior bracket 304 and the interior bracket 328 are made of plastic or any material that softens at elevated temperatures, the exterior bracket 304 and the interior bracket 328 may be reformed to adjust the angle 302 to any other angle greater than 90°. An example of such a reforming process is thermoforming. The material may soften at elevated temperature due to any related thermodynamic event, such as a glass transition temperature.

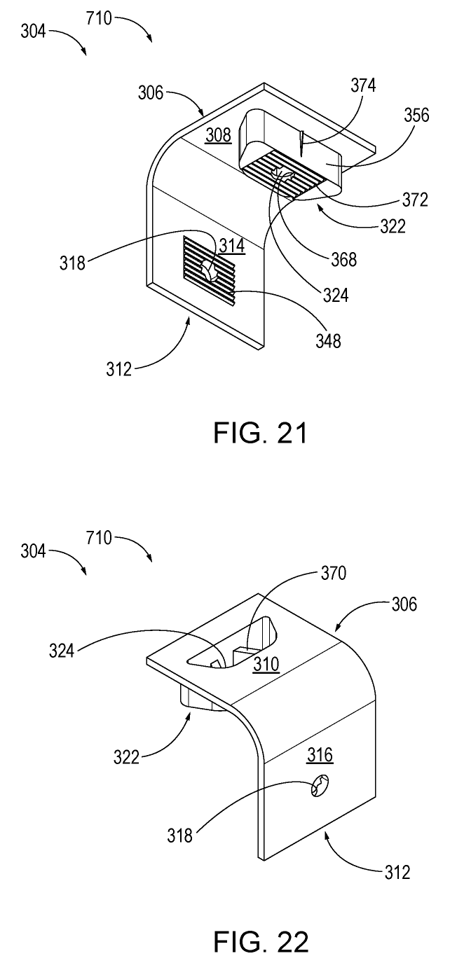

Turning now to FIGS. 21–32, illustrative non-exclusive examples of exterior brackets 304 and interior brackets 328 of bracket kits 300 and assemblies 400 are illustrated. Where appropriate, the reference numerals from the schematic illustrations of FIGS. 19 and 20 are used to designate corresponding parts of the examples of FIGS. 21–32; however, the examples of FIGS. 21–32 are non-exclusive and do not limit exterior brackets 304 and interior brackets 328 of bracket kits 300 and assemblies 400 to the illustrated examples. That is, exterior brackets 304 and interior brackets 328 of bracket kits 300 and assemblies 400 are not limited to the specific embodiments of FIGS. 21–32, and exterior brackets 304 and interior brackets 328 of bracket kits 300 and assemblies 400 may incorporate any number of the various aspects, configurations, characteristics, properties, etc. of exterior brackets 304 and interior brackets 328 of bracket kits 300 and assemblies 400 that are illustrated in and discussed with reference to the schematic representations of FIGS. 19 and 20 and/or the embodiments of FIGS. 21–32, as well as variations thereof, without requiring the inclusion of all such aspects, configurations, characteristics, properties, etc. For the purpose of brevity, each previously discussed component, part, portion, aspect, region, etc., or variants thereof may not be discussed, illustrated, and/or labeled again with respect to the embodiments of FIGS. 21–32; however, it is within the scope of the present disclosure that the previously discussed features, variants, etc. may be utilized with these embodiments.

FIGS. 21–22 illustrate a first example of an exterior bracket 304 of a bracket kit 300, indicated as 710. Exterior bracket 710 is an example of a monolithic and hollow exterior bracket 304, whose exterior-bracket second-wall inner face 314 extends at a right angle to the exterior-bracket first-wall inner face 308. Exterior bracket 710 comprises a first projection 322 having a generally isosceles trapezoidal profile with a lower-face width that is less than the upper-face width. The first projection 322 comprises a piercing rib 374 extending from the projection upper face 356 perpendicular to and tapering away from the exterior-bracket first-wall inner face 308. The first projection 322 further comprises a first-projection fastener hole 324 extending through the first projection 322. In addition, a plurality of projection ridges 372 are disposed around the first-projection fastener hole 324. The first projection 322 further comprises a fastener hold 370 disposed on a projection rear face 368 of the first projection 322. The exterior bracket 710 also comprises an exterior-bracket second-wall fastener hole 318 extending through an exterior-bracket second wall 312. In addition, the exterior bracket 710 comprises a plurality of exterior-bracket ridges 348 disposed around the exterior-bracket second-wall fastener hole 318 on the exterior-bracket second-wall inner face 314.

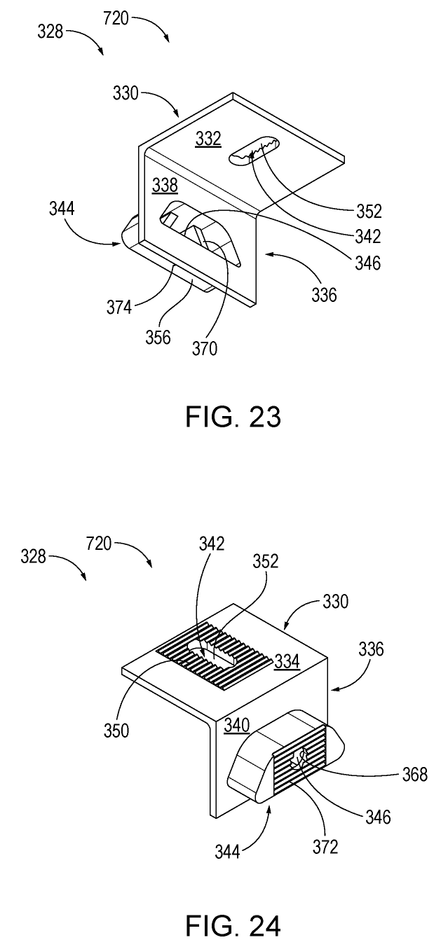

FIGS. 23–24 illustrate a first example of an interior bracket 328 of a bracket kit 300, indicated as 720. Interior bracket 720 is an example of a monolithic and hollow interior bracket 328, whose interior-bracket second-wall inner face 338 extends at a right angle to the interior-bracket first-wall inner face 332. Interior bracket 720 comprises a second projection 344 having a generally isosceles trapezoidal profile with a lower-face width that is less than the upper-face width. The second projection 344 comprises a piercing rib 374 extending from the projection upper face 356 of the second projection 344 perpendicular to and tapering away from the interior-bracket second-wall outer face 340. The second projection 344 further comprises a second-projection fastener hole 346 extending through the second projection 344. In addition, a plurality of projection ridges 372 are disposed around the second-projection fastener hole 346. The second projection 344 further comprises a fastener hold 370 disposed on a projection rear face 368 of the second projection 344. The interior bracket 720 also comprises an interior-bracket first-wall fastener hole 342 extending through an interior-bracket first wall 330 and along the interior-bracket first wall 330 defining an elongate channel 352. In addition, the interior bracket 720 comprises a plurality of interior-bracket ridges 350 disposed around the interior-bracket first-wall fastener hole 342 on an interior-bracket first-wall outer face 334.

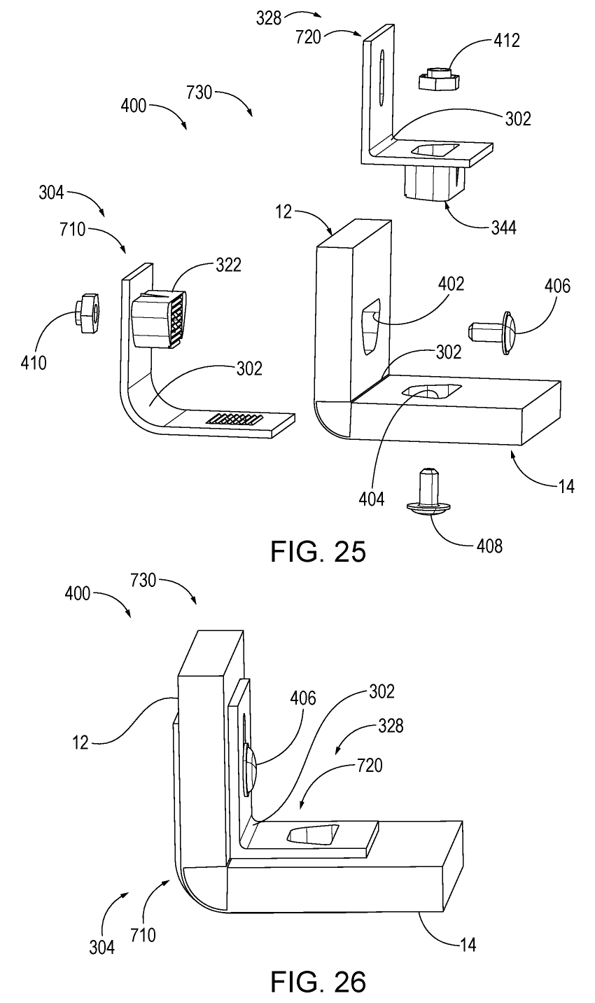

FIGS. 25 and 26 illustrate an example of an assembly 400, indicated as 730. Assembly 730 comprises exterior bracket 710, interior bracket 720, a first panel 12, a second panel 14, a first male fastener 406 in the form of a bolt, a second male fastener 408 in the form of a bolt, a first female fastener 410 in the form of a hex nut, and a second female fastener 412 in the form of a hex nut; each of the hex nuts is retained in a fastener hold 370 of the first projection 322 and the second projection 344 respectively.

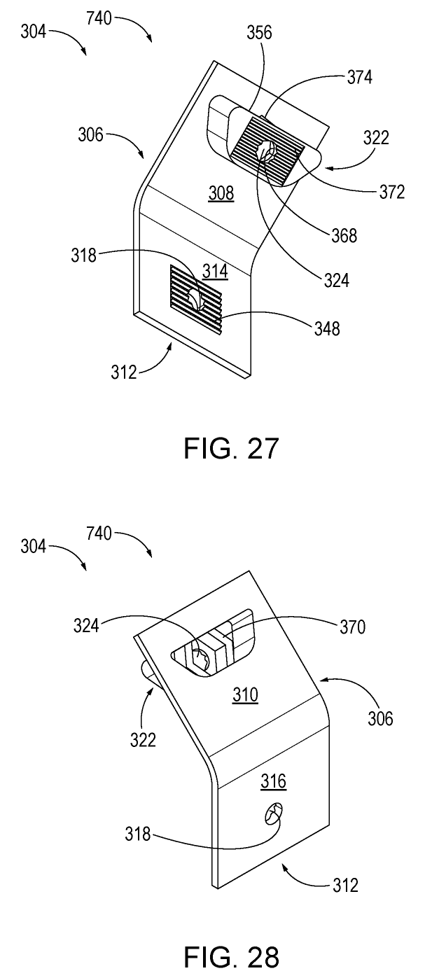

FIGS. 27 and 28 illustrate a second example of an exterior bracket 304 of a bracket kit 300, indicated as 740. Exterior bracket 740 is constructed similar to exterior bracket 710 of FIGS. 21 and 22; however, in exterior bracket 740, the exterior-bracket second-wall inner face 314 extends at an angle 302 greater than 90° to the exterior-bracket first-wall inner face 308.

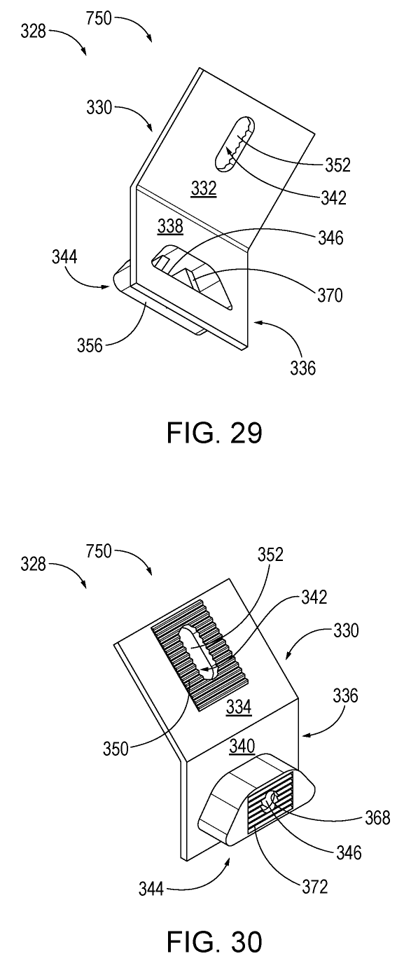

FIGS. 29 and 30 illustrate a second example of an interior bracket 328 of a bracket kit 300, indicated as 750. Interior bracket 750 is constructed similar to interior bracket 720 of FIGS. 23 and 24; however, in interior bracket 750 the interior-bracket second-wall inner face 338 extends at an angle 302 greater than 90° to the interior-bracket first-wall inner face 332.

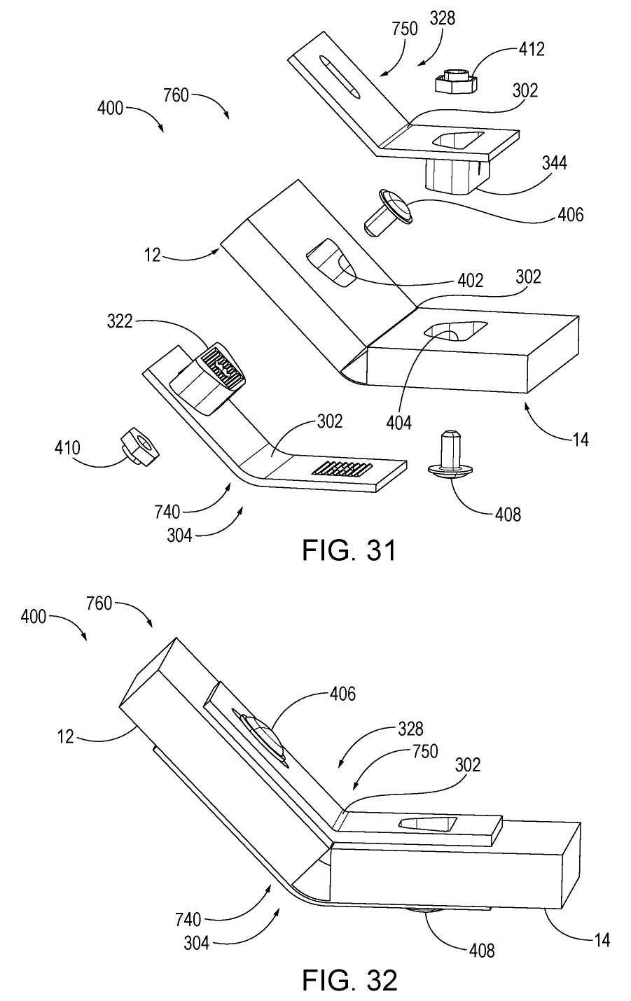

FIGS. 31 and 32 illustrate a second example of an assembly 400, indicated as 760. Assembly 760 is constructed similar to assembly 730 of FIGS. 25 and 26; however, assembly 760 has the exterior bracket 740 of FIGS. 27 and 28 and the interior bracket 750 of FIGS. 29 and 30.

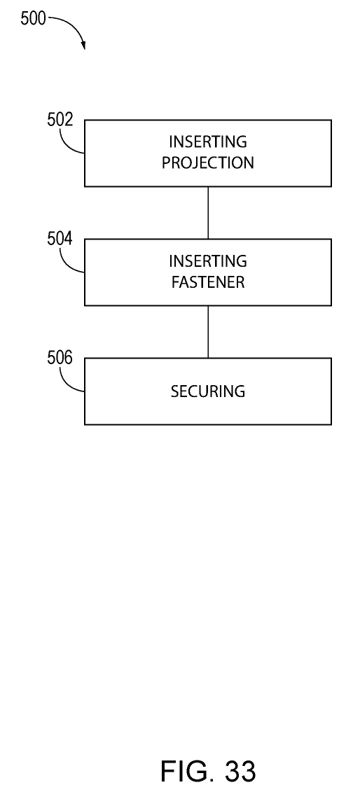

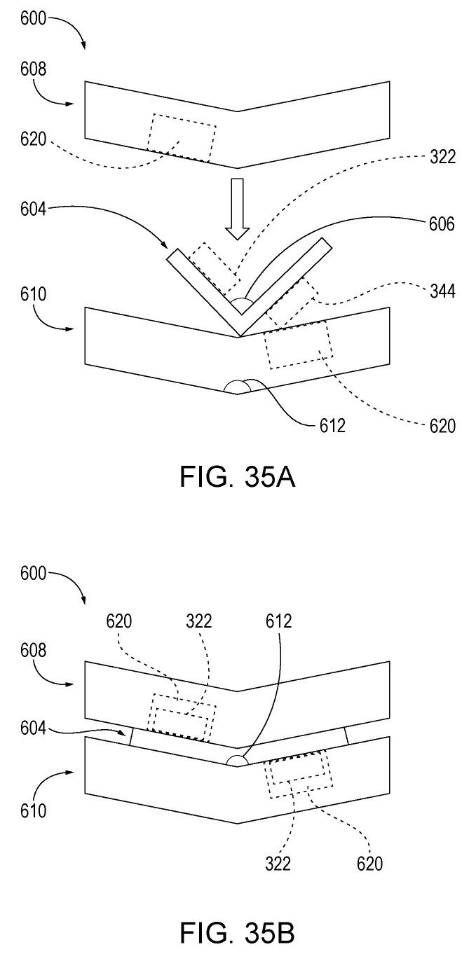

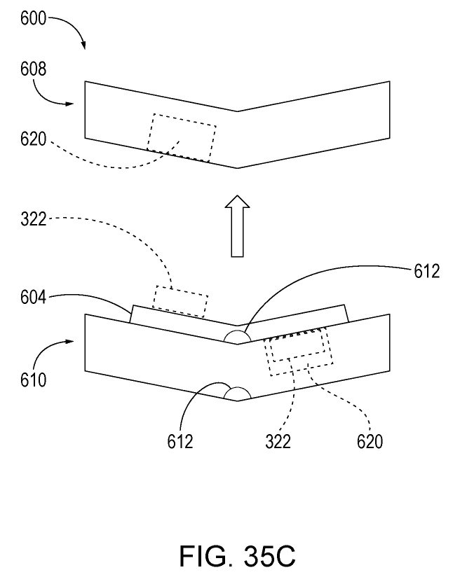

FIGS. 33–35 schematically represent illustrative, non-exclusive examples of methods 500 and 600 according to the present disclosure. FIG. 35 depicts an example schematic sequence according to methods 600. The example sequence and corresponding structures illustrated in FIG. 35 does not limit methods 600 according to the present disclosure, and any suitable sequence and structures within the scope of the present disclosure may be used in connection with methods 600. Additionally, not all methods according to the present disclosure are required to include the steps illustrated in solid boxes. The methods and steps illustrated in FIGS. 33–35 are not limiting and other methods and steps are within the scope of the present disclosure, including methods having greater than or fewer than the number of steps illustrated, as understood from the discussions herein.

With reference to FIGS. 19 and 33, methods 500 for assembling assemblies 400 comprise inserting 502 the first projection 322 through the first-panel projection slot 402, such that the first panel 12 engages the exterior-bracket first-wall inner face 308; inserting 502 the second projection 344 through the second-panel projection slot 404, such that the second panel 14 engages the interior-bracket second-wall outer face 340; inserting 504 the first male fastener 406 through the first-projection fastener hole 324; securing 506 the first male fastener 406 in place; inserting 504 the second male fastener 408 through the second-projection fastener hole 346; and securing 506 the second male fastener 408 in place.

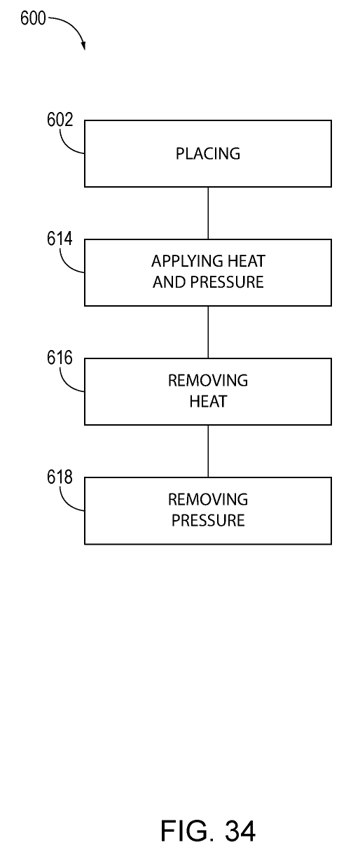

With reference to FIGS. 34 and 35, methods 600 for thermoforming a bracket 604 comprise placing 602 the bracket 604 defined by a first angle 606 between a heat and pressure-applying male mold 608 and a female mold 610 (FIG. 35A), wherein the molds 608 and 610 define a second angle 612 greater than the first angle 606; applying 614 pressure and heating the bracket 604 to at least a softening point, such that the bracket 604 is defined by the second angle 612 (FIG. 35C); removing 616 heat from the bracket 604; and removing 618 pressure after the bracket 604 cools below the softening point (FIG. 36C). In some examples, the bracket 604 is an injection-molded part with a first angle 606 equal to 90°. In some further examples, the bracket 604 may be the exterior bracket 304 or the interior bracket 328 of bracket kits 300 according to any of the subject matter disclosed above. In some such examples, each of the heat and pressure-applying male mold 608 and the female mold 610 include a recession 620. The recession 620 of the heat and pressure-applying male mold 608 is configured to receive the first projection 322, and the recession 620 of the female mold 610 is configured to receive the second projection 344. In such methods 600, the recessions 620 preserve the structures of the projections during bracket thermoforming.

Illustrative, non-exclusive examples of inventive subject matter according to the present disclosure are described in the following enumerated paragraphs:

A. A bracket (10) for coupling a first panel (12) to a second panel (14) at an angle, the bracket (10) comprising:

a first wall (16) having a first-wall inner face (18) and a first-wall outer face (20) opposite the first-wall inner face (18);

a second wall (22) having a second-wall inner face (24) and a second-wall outer face (26) opposite the second-wall inner face (24), wherein the second-wall inner face (24) extends at the angle to the first-wall inner face (18), and wherein the second wall (22) defines a second-wall fastener hole (28) extending through the second wall (22); and

a hollow projection (30) extending from the first-wall inner face (18) and defining a projection fastener hole (32) extending through the hollow projection (30) and co-axially aligned with the second-wall fastener hole (28).

A1. The bracket (10) of paragraph A, further comprising a cantilever clip (34) extending away from the first-wall inner face (18).

A1.1. The bracket (10) of paragraph A1, wherein the cantilever clip (34) comprises a hook (36) extending away from the second-wall inner face (24).

A1.1.1. The bracket (10) of any of paragraphs A1–A1.1, wherein the cantilever clip (34) is configured to have a snap-fit arrangement with the first panel (12).

A2. The bracket (10) of any of paragraphs A–A1.1.1, wherein the hollow projection (30) comprises:

a projection lower face (38) facing the second-wall inner face (24);

a projection upper face (40) opposite the projection lower face (38) and facing away from the second-wall inner face (24);

a projection left face (42) extending between the projection lower face (38) and the projection upper face (40); and

a projection right face (44) opposite the projection left face (42) and extending between the projection lower face (38) and the projection upper face (40).

A2.1. The bracket (10) of paragraph A2,

wherein the projection lower face (38) has a lower-face width (46);

wherein the projection upper face (40) has an upper-face width (49); and

wherein the lower-face width (46) is less than the upper-face width (49).

A2.2. The bracket (10) of any of paragraphs A2–A2.1, wherein the projection lower face (38) extends further from the first-wall inner face (18) than the projection upper face (40).

A2.3. The bracket (10) of any of paragraphs A2–A2.2, wherein the projection fastener hole (32) extends through the projection lower face (38) but not through the projection upper face (40).

A2.4. The bracket (10) of any of paragraphs A2–A2.3, when depending from paragraph A1, wherein the cantilever clip (34) has a cantilever-clip upper face (52) that is parallel to the projection upper face (40).

A2.5. The bracket (10) of any of paragraphs A2–A2.4, when depending from paragraph A1, wherein the projection upper face (40) defines a gap (54), and wherein the cantilever clip (34) extends within the gap (54).

A2.5.1. The bracket (10) of paragraph A2.5, when depending from paragraph A1, wherein the cantilever-clip upper face (52) is co-planar with the projection upper face (40).

A3. The bracket (10) of any of paragraphs A–A2.5.1, wherein the hollow projection (30) has a generally trapezoidal profile.

A4. The bracket (10) of any of paragraphs A–A3, wherein the hollow projection (30) has a generally isosceles trapezoidal profile.

A5. The bracket (10) of any of paragraphs A–A4, further comprising one or more first-wall reinforcing ribs (48) extending from the first-wall outer face (20).

A6. The bracket (10) of any of paragraphs A–A5, further comprising one or more second-wall reinforcing ribs (50) extending from the second-wall outer face (26).

A6.1. The bracket (10) of paragraph A6, when depending from paragraph A5, wherein the one or more second-wall reinforcing ribs (50) are coextensive with the one or more first-wall reinforcing ribs (48).

A7. The bracket (10) of any of paragraphs A–A6.1, further comprising one or more second-wall piercing ribs (58) extending from the second-wall inner face (24), perpendicular to the first-wall inner face (18), and tapering away from the first-wall inner face (18).

A8. The bracket (10) of any of paragraphs A–A7, further comprising one or more projection piercing ribs (60) extending away from the hollow projection (30), perpendicular to the first-wall inner face (18), and tapering away from the first-wall inner face (18).

A8.1. The bracket (10) of paragraph A8, when depending from paragraph A3, wherein the one or more projection piercing ribs (60) extend from the projection upper face (40).

A9. The bracket (10) of any of paragraphs A–A8.1, wherein the angle is a right angle.

A10. The bracket (10) of any of paragraphs A–A9, wherein the bracket (10) is monolithic.

B. An assembly (62) comprising:

the bracket (10) of any of paragraphs A–A10;

the first panel (12) engaged with the first-wall inner face (18), wherein the first panel (12) defines a first-panel projection slot (64), through which the hollow projection (30) extends;

the second panel (14) engaged with the second-wall inner face (24), wherein the second panel (14) defines a second-panel fastener hole (66) co-axially aligned with the second-wall fastener hole (28) and the projection fastener hole (32); and

a male fastener (68) extending through the second-wall fastener hole (28), the second-panel fastener hole (66), and the projection fastener hole (32).

B1. The assembly (62) of paragraph B, further comprising a female fastener (70) operatively coupled to the hollow projection (30) and operatively mated with the male fastener (68).

B2. The assembly (62) of any of paragraphs B–B1, further comprising a bushing (72) positioned within the second-panel fastener hole (66), wherein the male fastener (68) extends through the bushing (72).

B3. The assembly (62) of any of paragraphs B–B2, wherein the first panel (12) and the second panel (14) are sandwich panels.

B3.1. The assembly (62) of paragraph B3, wherein the first panel (12) and the second panel (14) each comprise opposing face sheets (74) and a honeycomb core (76).

B4. The assembly (62) of any of paragraphs B–B3.1, wherein the hollow projection (30) has a projection profile, and wherein the first-panel projection slot (64) has a projection-hole profile that is concentric with the projection profile.

B5. The assembly (62) of any of paragraphs B–B4, when depending from paragraph A1.1, wherein the hook (36) engages the first panel (12) opposite the first-wall inner face (18).

B6. The assembly (62) of any of paragraphs B–B5, when depending from paragraph A8, wherein the one or more second-wall piercing ribs (58) extend into the first panel (12).

B6.1. The assembly (62) of paragraph B6, wherein the one or more second-wall piercing ribs (58) extend into the second panel (14).

B7. The assembly (62) of any of paragraphs B–B6.1, when depending from paragraph A9, wherein the one or more projection piercing ribs (60) extend into the first panel (12).

B8. The assembly (62) of any of paragraphs B–B7, wherein the assembly (62) defines an aerospace assembly (106).

B8.1. The assembly (62) of paragraph B8, wherein the assembly (62) defines an aircraft stowage bin (108), an aircraft closet or cabinet (110), an aircraft shelving unit (112), an aircraft crew rest compartment (114), an aircraft lavatory (116), or an aircraft interior bulkhead (118).

B9. The assembly (62) of any of paragraphs B–B8.1, wherein the assembly (62) is free of adhesive between the bracket (10) and the first panel (12) and between the bracket (10) and the second panel (14).

C. An aircraft (100), comprising a fuselage (102) defining an interior (104) and an aerospace assembly (106) positioned within the interior (104), wherein the aerospace assembly (106) comprises the assembly (62) of any of paragraphs B–B9.

D. A method of assembling the assembly (62) of any of paragraphs B–B9, the method comprising:

inserting the hollow projection (30) through the first-panel projection slot (64) such that the first panel (12) engages the first-wall inner face (18);

engaging the second panel (14) with the second-wall inner face (24) and with the first panel (12);

inserting the male fastener (68) through the second-wall fastener hole (28), the second-panel fastener hole (66), and the projection fastener hole (32); and

securing the male fastener (68) in place.

E. A method of manufacturing the bracket (10) of any of paragraphs A–A10, the method comprising injection-molding the bracket (10).

F. A bracket kit (300) for coupling a first panel (12) to a second panel (14) at an angle (302), the bracket kit (300) comprising:

an exterior bracket (304) comprising:

an exterior-bracket first wall (306) having an exterior-bracket first-wall inner face (308) and an exterior-bracket first-wall outer face (310) opposite the exterior-bracket first-wall inner face (308);

an exterior-bracket second wall (312) having an exterior-bracket second-wall inner face (314) and an exterior-bracket second-wall outer face (316) opposite the exterior-bracket second-wall inner face (314), wherein the exterior-bracket second-wall inner face (314) extends at the angle (302) to the exterior-bracket first-wall inner face (308), and wherein the exterior-bracket second wall (312) defines an exterior-bracket second-wall fastener hole (318) extending through the exterior-bracket second wall (312) along a first axis (320); and

a first projection (322) extending from the exterior-bracket first-wall inner face (308) and defining a first-projection fastener hole (324) extending through the first projection (322) along a second axis (326);

an interior bracket (328) comprising:

an interior-bracket first wall (330) having an interior-bracket first-wall inner face (332) and an interior-bracket first-wall outer face (334) opposite the interior-bracket first-wall inner face (332);

an interior-bracket second wall (336) having an interior-bracket second-wall inner face (338) and an interior-bracket second-wall outer face (340) opposite the interior-bracket second-wall inner face (338), wherein the interior-bracket second-wall inner face (338) extends at the angle (302) to the interior-bracket first-wall inner face (332), and wherein the interior-bracket first wall (330) defines an interior-bracket first-wall fastener hole (342) extending through the interior-bracket first wall (330) along the second axis (326); and

a second projection (344) extending from the interior-bracket second-wall outer face (340) and defining a second-projection fastener hole (346) extending through the second projection (344) along the first axis (320); and

wherein when the bracket kit (300) is operatively positioned relative to the first panel (12) and the second panel (14), the first projection (322) extends through the first panel (12) and the second projection (344) extends through the second panel (14).

F1. The bracket kit (300) of paragraph F, wherein a portion of the exterior-bracket second-wall inner face (314) comprises a plurality of exterior-bracket ridges (348).

F1.1. The bracket kit (300) of paragraph F1, wherein the plurality of exterior-bracket ridges(348) are disposed around the exterior-bracket second-wall fastener hole (318).

F2. The bracket kit (300) of any of paragraphs F–F1.1, wherein a portion of the interior-bracket first-wall outer face (334) comprises a plurality of interior-bracket ridges (350).

F2.1. The bracket kit (300) of paragraph F2, wherein the plurality of interior-bracket ridges (350) are disposed around the interior-bracket first-wall fastener hole (342).

F3. The bracket kit (300) of paragraphs F–F2.1, wherein the interior-bracket first-wall fastener hole (342) further extends along the interior-bracket first wall (330) perpendicular to the second axis (326) and defines an elongate channel (352).

F4. The bracket kit (300) of any of paragraphs F–F3, wherein each of the first projection (322) and the second projection (344) comprises:

a projection lower face (354);

a projection upper face (356) opposite the projection lower face (354);

a projection left face (358) extending between the projection lower face (354) and the projection upper face (356);

a projection right face (360) opposite the projection left face (358) and extending between the projection lower face (354) and the projection upper face (356); and

a projection front face (362) extending between the projection lower face (354), the projection upper face (356), the projection left face (358), and the projection right face (360).

F4.1. The bracket kit (300) of paragraph F4, wherein the projection lower face (354) has a lower-face width (364); and wherein the projection upper face (356) has an upper-face width (366).

F4.1.1 The bracket kit (300) of paragraph F4.1, wherein the lower-face width (364) is less than the upper-face width (366).

F4.2. The bracket kit (300) of any of paragraphs F4–F4.1.1, wherein each of the first projection (322) and the second projection (344) further comprises a projection rear face (368) opposite the projection front face (362).

F4.2.1. The bracket kit (300) of paragraph F4.2, wherein each of the first projection (322) and the second projection (344) comprises a fastener hold (370) disposed on the projection rear face (368).

F4.3. The bracket kit (300) of any of paragraphs F4–F4.2.1, wherein the first-projection fastener hole (324) extends through the projection front face (362) of the first projection (322).

F4.4. The bracket kit (300) of any of paragraphs F4–F4.3, wherein the second-projection fastener hole (346) extends through the projection front face (362) of the second projection (344).

F4.5. The bracket kit (300) of any of paragraphs F4–F4.4, wherein the projection lower face (354) of the first projection (322) faces the exterior-bracket second-wall inner face (314) when operatively positioned relative to the first panel (12) and the second panel (14); wherein the projection upper face (356) of the first projection (322) faces away from the exterior-bracket second-wall inner face (314) when operatively positioned relative to the first panel (12) and the second panel (14); wherein the projection front face (362) of the first projection (322) faces away from the exterior-bracket first-wall inner face (308) when operatively positioned relative to the first panel (12) and the second panel (14); wherein the projection lower face (354) of the second projection (344) faces the interior-bracket first wall (330) when operatively positioned relative to the first panel (12) and the second panel (14); wherein the projection upper face (356) of the second projection (344) faces away from the interior-bracket first wall (330) when operatively positioned relative to the first panel (12) and the second panel (14); and wherein the projection front face (362) of the second projection (344) faces away from the interior-bracket second-wall outer face (340) when operatively positioned relative to the first panel (12) and the second panel (14).

F4.6. The bracket kit (300) of any of paragraphs F4–F4.5, wherein a portion of the projection front face (362) comprises a plurality of projection ridges (372).

F4.6.1. The bracket kit (300) of paragraph F4.6, wherein the plurality of projection ridges (372) of the first projection (322) is disposed around the first-projection fastener hole (324).

F4.6.2. The bracket kit (300) of any of paragraphs F4.6–F4.6.1, wherein the plurality of projection ridges (372) of the second projection (344) is disposed around the second-projection fastener hole (346).

F5. The bracket kit (300) of any of paragraphs F–F4.6.2, wherein each of the first projection (322) and the second projection (344) further comprises a piercing rib (374).

F5.1. The bracket kit (300) of paragraph F5, wherein the piercing rib (374) extends from a/the projection upper face (356).

F5.2. The bracket kit (300) of any of paragraphs F5–F5.1, wherein the piercing rib (374) of the first projection (322) extends away from the first projection (322) perpendicular to the exterior-bracket first-wall inner face (308) and tapers away from the exterior bracket first-wall inner face (308).

F5.3. The bracket kit (300) of any of paragraphs F5–F5.2, wherein the piercing rib (374) of the second projection (344) extends away from the second projection (344) perpendicular to the interior-bracket second-wall outer face (340) and tapers away from the interior-bracket second-wall outer face (340).

F6. The bracket kit (300) of any of paragraphs F–F5.3, wherein each of the first projection (322) and the second projection (344) has a generally trapezoidal profile.

F7. The bracket kit (300) of any of paragraphs F–F6, wherein each of the first projection (322) and the second projection (344) has a generally isosceles trapezoidal profile.

F8. The bracket kit (300) of any of paragraphs F–F7, wherein each of the first projection (322) and the second projection (344) is hollow.

F9. The bracket kit (300) of any of paragraphs F–F8, wherein the angle (302) is greater than or equal to 90°.

F10. The bracket kit (300) of any of paragraphs F–F9, wherein each of the exterior bracket (304) and the interior bracket (328) is monolithic.

F11. The bracket kit (300) of any of paragraphs F–F10, wherein the exterior bracket (304) and the interior bracket (328) are composed of the same material.

G. An assembly (400) comprising:

the bracket kit (300) of any of paragraphs F–F11;

the first panel (12) engaged with the exterior-bracket first-wall inner face (308), wherein the first panel (12) defines a first-panel projection slot (402), through which the first projection (322) extends;

the second panel (14) engaged with the interior-bracket second-wall inner face (338), wherein the second panel (14) defines a second-panel projection slot (404) through which the second projection (344) extends;

a first male fastener (406) extending through the first-projection fastener hole (324) and the interior-bracket first-wall fastener hole (342); and

a second male fastener (408) extending through the second-projection fastener hole (346) and the exterior-bracket second-wall fastener hole (318).

G1. The assembly (400) of paragraph G, further comprising:

a first female fastener (410) operatively coupled to the first projection (322) and operatively mated with the first male fastener (406); and

a second female fastener (412) operatively coupled to the second projection (344) and operatively mated with the second male fastener (408).

G1.1. The assembly (400) of paragraph G1, when depending from paragraph F4.2.1, wherein the fastener hold (370) of the first projection (322) retains the first female fastener (410), wherein the first male fastener (406) extends through the fastener hold (370); and wherein the fastener hold (370) of the second projection (344) retains the second female fastener (412), wherein the second male fastener (408) extends through the fastener hold (370).

G2. The assembly (400) of any of paragraphs G–G1.1, wherein the first panel (12) and the second panel (14) are sandwich panels.

G2.1. The assembly (400) of paragraph G2, wherein the first panel (12) and the second panel (14) each comprise opposing face sheets (414) and a honeycomb core (416).

G3. The assembly (400) of any of paragraphs G–G2.1, wherein the first projection (322) and the second projection (344) each have a respective projection profile, wherein the first-panel projection slot (402) and the second-panel projection slot (404) each have a respective projection-hole profile, and wherein the respective projection profiles are concentric with the respective projection-hole profiles.

G4. The assembly (400) of any of paragraphs G–G3, when depending from paragraph F5, wherein the piercing rib (374) of the first projection (322) extends into the first panel (12); and wherein the piercing rib (374) of the second projection (344) extends into the second panel (14).

G5. The assembly (400) of any of paragraphs G–G4, wherein the assembly (400) defines an aerospace assembly (204).

G5.1. The assembly (400) of paragraph G5, wherein the assembly (400) defines an aircraft stowage bin (108), an aircraft closet or cabinet (110), an aircraft shelving unit (112), an aircraft crew rest compartment (114), an aircraft lavatory (116), or an aircraft interior bulkhead (118).

G6. The assembly (400) of any of paragraphs G–G5.1, wherein the assembly (400) is free of adhesive.

H. An aircraft (100), comprising a fuselage (102) defining an interior (104) and an aerospace assembly (106) positioned within the interior (104), wherein the aerospace assembly (106) comprises the assembly (400) of any of paragraphs G–G6.

I. A method (500) of assembling the assembly (400) of any of paragraphs G–G6, the method (500) comprising:

inserting (502) the first projection (322) through the first-panel projection slot (402), such that the first panel (12) engages the exterior-bracket first-wall inner face (308);

inserting (502) the second projection (344) through the second-panel projection slot (404), such that the second panel (14) engages the interior-bracket second-wall outer face (340);

inserting (504) the first male fastener (406) through the first-projection fastener hole (324);

securing (506) the first male fastener (406) in place;

inserting (504) the second male fastener (408) through the second-projection fastener hole (346); and

securing (506) the second male fastener (408) in place.

J. A method of manufacturing the bracket kit (300) of any of paragraphs F–F11, the method comprising injection-molding the exterior bracket (304) and/or the interior bracket (328).

K. A method (600) of thermoforming a bracket (604), the method (600) comprising:

placing (602) a bracket (604) defined by a first angle (606) between a heat and pressure-applying male mold (608) and a female mold (610), wherein the molds (610) and (608) defines a second angle (612) greater than the first angle (606);

applying (614) pressure and heating the bracket (604) past a softening point, such that the bracket (604) is defined by the second angle (612);

removing (616) heat from the bracket (604); and

removing (618) pressure responsive to the bracket (604) cooling below the softening point.

K1.1. The method (600) of paragraph K1, wherein the bracket (604) is an injection-molded part.

K2. The method (600) of any of paragraphs K–K1.1, wherein the first angle (606) is 90°.

K3. The method (600) of any of paragraphs K–K2, wherein the bracket (604) comprises the exterior bracket (304) or the interior bracket (328) of any of paragraphs F–F11.

K3.1 The method (600) of paragraph K3, wherein each of the heat and pressure-applying male mold (608) and the female mold (610) include a recession (620), wherein the recession (620) of the heat and pressure-applying male mold (608) is configured to receive the first projection (322), and wherein the recession (620) of the female mold (610) is configured to receive the second projection (344).

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A bracket kit for coupling a first panel to a second panel at an angle, the bracket kit comprising:
an exterior bracket comprising:
an exterior-bracket first wall having an exterior-bracket first-wall inner face and an exterior-bracket first-wall outer face opposite the exterior-bracket first-wall inner face;
an exterior-bracket second wall having an exterior-bracket second-wall inner face and an exterior-bracket second-wall outer face opposite the exterior-bracket second-wall inner face, wherein the exterior-bracket second-wall inner face extends at the angle to the exterior-bracket first-wall inner face, and wherein the exterior-bracket second wall defines an exterior-bracket second-wall fastener hole extending through the exterior-bracket second wall along a first axis; and
a first projection extending from the exterior-bracket first-wall inner face and defining a first-projection fastener hole extending through the first projection along a second axis;
an interior bracket comprising:
an interior-bracket first wall having an interior-bracket first-wall inner face and an interior-bracket first-wall outer face opposite the interior-bracket first-wall inner face;
an interior-bracket second wall having an interior-bracket second-wall inner face and an interior-bracket second-wall outer face opposite the interior-bracket second-wall inner face, wherein the interior-bracket second-wall inner face extends at the angle to the interior-bracket first-wall inner face, and wherein the interior-bracket first wall defines an interior-bracket first-wall fastener hole extending through the interior-bracket first wall along the second axis; and
a second projection extending from the interior-bracket second-wall outer face and defining a second-projection fastener hole extending through the second projection along the first axis; and
wherein when the bracket kit is operatively positioned relative to the first panel and the second panel, the first projection extends towards the first panel and the second projection extends towards the second panel.

2. The bracket kit of claim 1, wherein a portion of the exterior-bracket second-wall inner face comprises a plurality of exterior-bracket ridges.

3. The bracket kit of claim 2, wherein the plurality of exterior-bracket ridges are disposed around the exterior-bracket second-wall fastener hole.

4. The bracket kit of claim 1, wherein a portion of the interior-bracket first-wall outer face comprises a plurality of interior-bracket ridges.

5. The bracket kit of claim 4, wherein the plurality of interior-bracket ridges are disposed around the interior-bracket first-wall fastener hole.

6. The bracket kit of claim 1, wherein the interior-bracket first-wall fastener hole further extends along the interior-bracket first-wall perpendicular to the second axis and defines an elongate channel.

7. The bracket kit of claim 1, wherein each of the first projection and the second projection comprises:
a projection lower face;
a projection upper face opposite the projection lower face;
a projection left face extending between the projection lower face and the projection upper face;
a projection right face opposite the projection left face and extending between the projection lower face and the projection upper face; and
a projection front face extending between the projection lower face, the projection upper face, the projection left face, and the projection right face.

8. The bracket kit of claim 7, wherein the projection lower face of the first projection faces the exterior-bracket second-wall inner face when operatively positioned relative to the first panel and the second panel; wherein the projection upper face of the first projection faces away from the exterior-bracket second-wall inner face when operatively positioned relative to the first panel and the second panel; wherein the projection front face of the first projection faces away from the exterior-bracket first-wall inner face when operatively positioned relative to the first panel and the second panel; wherein the projection lower face of the second projection faces the interior-bracket first wall when operatively positioned relative to the first panel and the second panel; wherein the projection upper face of the second projection faces away from the interior-bracket first wall when operatively positioned relative to the first panel and the second panel; and wherein the projection front face of the second projection faces away from the interior-bracket second-wall outer face when operatively positioned relative to the first panel and the second panel.

9. The bracket kit of claim 7, wherein the projection lower face has a lower-face width, wherein the projection upper face has an upper-face width, and wherein the lower-face width is less than the upper-face width.

10. The bracket kit of claim 7, wherein a portion of the projection front face comprises a plurality of projection ridges.

11. The bracket kit of claim 10, wherein the plurality of projection ridges of the first projection is disposed around the first-projection fastener hole, and wherein the projection ridges of the second projection is disposed around the second-projection fastener hole.

12. The bracket kit of claim 7, wherein each of the first projection and the second projection further comprises:
a projection rear face opposite the projection front face; and
a fastener hold disposed on the projection rear face.

13. The bracket kit of claim 1, wherein each of the first projection and the second projection has a generally trapezoidal profile.

14. The bracket kit of claim 1, wherein each of the exterior bracket and the interior bracket is monolithic.

15. The bracket kit of claim 1, wherein the angle is greater than or equal to 90°.

16. An assembly comprising:
the bracket kit of claim 1;
the first panel engaged with the exterior-bracket first-wall inner face, wherein the first panel defines a first-panel projection slot, through which the first projection extends;
the second panel engaged with the interior-bracket second-wall inner face, wherein the second panel defines a second-panel projection slot through which the second projection extends;
a first male fastener extending through the first-projection fastener hole and the interior-bracket first-wall fastener hole; and
a second male fastener extending through the second-projection fastener hole and the exterior-bracket second-wall fastener hole.

17. A method of assembling the assembly of claim 16, the method comprising:
inserting the first projection through the first-panel projection slot, such that the first panel engages the exterior-bracket first-wall inner face;
inserting the second projection through the second-panel projection slot, such that the second panel engages the interior-bracket second-wall outer face;
inserting the first male fastener through the first-projection fastener hole;
securing the first male fastener in place;
inserting the second male fastener through the second-projection fastener hole; and
securing the second male fastener in place.

18. A method of manufacturing the bracket kit of claim 1, the method comprising:
injection-molding each of the exterior bracket and the interior bracket.

19. A method of thermoforming a bracket, the method comprising:
placing the bracket defined by a first angle between a heat and pressure-applying male mold and a female mold, wherein the molds define a second angle greater than the first angle;
applying pressure and heating the bracket through a softening point, such that the bracket is defined by the second angle;
removing heat from the bracket; and
removing pressure responsive to the bracket cooling below the softening point.

20. The method of claim 19, wherein the first angle is 90°.
